(19) United States
(12) Patent Application Publication
(10) Pub. No.: US 2026/0104129 A1
(43) Pub. Date: Apr. 16, 2026

(54) Terminal Stand

(71) Applicant: SHENZHEN HAOHUALIANHE TECHNOLOGY CO., LTD., Shenzhen (CN)

(72) Inventor: Weihao Chen, Shenzhen (CN)

(21) Appl. No.: 19/421,647

(22) Filed: Dec. 16, 2025

Related U.S. Application Data
(63) Continuation of application No. PCT/CN2024/080201, filed on Mar. 5, 2024.

(30) Foreign Application Priority Data
Mar. 5, 2023 (CN) 202320483270.7

(51) Int. Cl. F16M 11/10; F16M 11/18; G03B 17/56

(52) U.S. Cl. CPC F16M 11/10; F16M 11/18; G03B 17/561

(57) ABSTRACT

A terminal stand, including a support member, a gimbal assembly, a connecting arm, a power source, and a holding member. The support member is configured to support the gimbal assembly, the connecting arm, the power source, and the holding member. The gimbal assembly includes a fixing assembly, a rotating assembly, and a driving assembly; the fixing assembly is arranged on the support member; the rotating assembly is rotatable relative to the fixing assembly about a first rotation axis; the driving assembly is arranged within the installation space of the gimbal assembly and is configured to drive the rotating assembly to rotate relative to the fixing assembly; the connecting arm is arranged on the rotating assembly; the power source is located outside the gimbal assembly and is electrically connected to the driving assembly; the holding member is arranged on the connecting arm and is configured to hold an electronic terminal.

### CROSS-REFERENCE TO RELATED APPLICATIONS

The present application is a continuation-application of International (PCT) Patent Application No. PCT/CN2024/080201, filed on Mar. 5, 2024, which claims priority of Chinese Patent Application No. 202320483270.7, filed on Mar. 5, 2023 and Chinese Patent Application No. 202320517261.5, filed on Mar. 5, 2023, in the China National Intellectual Property Administration. The entire contents of International (PCT) Patent Application No. PCT/CN2024/080201, Chinese Patent Application No. 202320483270.7, and Chinese Patent Application No. 202320517261.5 are hereby incorporated by reference in their entireties.

### TECHNICAL FIELD

The present disclosure relates to the technical field of support devices for electronic products, and specifically, to a terminal stand.

### BACKGROUND

A terminal stand is a bracket configured to support electronic terminals such as mobile phones and tablets. It is configured to hold the electronic terminal at a suitable height or angle for convenient use.

A terminal stand typically includes a support member, a gimbal, and a holding member. The gimbal is configured to connect the support member and the holding member. The holding member is configured to directly bear the electronic terminal. The gimbal is generally rotatable to adjust the usage orientation of the electronic terminal. Gimbals may be categorized into manual gimbals and motorized gimbals.

In the related art, in an existing terminal stand, the motorized gimbal includes a fixed portion, a rotating portion, a drive assembly, and a power source. The fixed portion is secured to the support member, while the rotating part is capable of rotating relative to the fixed portion. The motorized gimbal defines an installation space where the drive assembly and power source are housed. To ensure sufficient battery life for the motorized gimbal, the power source occupies a relatively large space, resulting in a bulky gimbal structure. This increased size makes the terminal stand inconvenient for storage and portability.

### SUMMARY OF THE DISCLOSURE

A terminal stand is provided to address the shortcomings and deficiencies of the related art.

The present disclosure provides a terminal stand, including a support member, a gimbal assembly, a connecting arm, a power source, and a holding member;
wherein the support member is configured to support the gimbal assembly, the connecting arm, the power source, and the holding member;
the gimbal assembly includes a fixing assembly, a rotating assembly, and a driving assembly; the fixing assembly is arranged on the support member; the rotating assembly is rotatable relative to the fixing assembly about a first rotation axis; the gimbal assembly defines an installation space, and the driving assembly is arranged within the installation space and is configured to drive the rotating assembly to rotate relative to the fixing assembly;
the connecting arm is arranged on the rotating assembly; the power source is located outside the gimbal assembly and is electrically connected to the driving assembly;
the holding member is arranged on the connecting arm and is configured to hold an electronic terminal.

In some embodiments, the connecting arm defines an accommodation cavity, and the power source is arranged within the accommodation cavity.

In some embodiments, the driving assembly is arranged on the rotating assembly, and the connecting arm is rotatably arranged on the rotating assembly about a second rotation axis;
the terminal stand includes a connecting wire; an end of the connecting wire extends to the accommodation cavity, and another end of the connecting wire extends to the installation space; the connecting wire is configured to supply power from the power source to the driving assembly;
the rotating assembly is arranged with a first wire passage for the connecting wire to pass through, the first wire passage communicating with the installation space;
the connecting arm is arranged with a second wire passage for the connecting wire to pass through, the second wire passage communicating with the first wire passage and communicating with the accommodation cavity;
during rotation of the connecting arm relative to the rotating assembly about the second rotation axis, the first wire passage and the second wire passage remain communicated to facilitate the connecting wire passing through the first wire passage and the second wire passage.

In some embodiments, the first wire passage includes a first wire port near the second wire passage, the second wire passage includes a second wire port near the first wire passage, and the first wire port and the second wire port are connected to or close to each other;
both the first wire port and the second wire port are revolving ports, and both are coaxial with the second rotation axis.

In some embodiments, the rotating assembly includes a first installation protrusion and a second installation protrusion that are spaced apart, and the first wire passage extends to the first installation protrusion;
the connecting arm includes a connection protrusion, the connection protrusion including a first connection portion and a second connection portion that are arranged side by side;
the second wire passage extends to the first connection portion; the first connection portion is connected to or close to the first installation protrusion, causing the first wire passage to be communicated with the second wire passage;
the second connection portion is rotatably arranged on the second installation protrusion, causing the connecting arm to be rotatably arranged on the rotating assembly.

In some embodiments, the terminal stand further includes a first rotation pin; the first rotation pin passes through the second connection portion and the second installation protrusion to rotatably arrange the second connection portion on the second installation protrusion;
a first fastener serves as the first rotation pin and is further configured to hold the connecting arm in position relative to the rotating assembly;
the second connection portion includes at least one first connection plate spaced apart; the second installation protrusion includes at least one second connection plate arranged spaced apart; the at least one first connection plate and the at least one second connection plate are arranged in an interleaved manner, and both the first connection plate and the second connection plate are sheet-like;
the first fastener is configured to cause an adjacent set of a corresponding first connection plate and a corresponding second connection plate to be in tight contact.

In some embodiments, the terminal stand further includes a first rotation pin; the first rotation pin passes through the second connection portion and the second installation protrusion to rotatably arrange the second connection portion on the second installation protrusion;
a first fastener serves as the first rotation pin and is further configured to hold the connecting arm in position relative to the rotating assembly;
the first fastener includes a nut and a screw that are configured to be cooperatively engaged; in a case where the second connection portion rotates relative to the second installation protrusion, both the nut and the screw remain stationary relative to the second installation protrusion, or both the nut and the screw remain stationary relative to the second connection portion;
the first connection portion is located between the first installation protrusion and the second installation protrusion, and the first connection portion defines an accommodation groove, the nut being accommodated in the accommodation groove;
the nut is peripherally fixed relative to the second installation protrusion or the second connection portion about the second rotation axis; a head of the screw includes an adjustment portion, and the adjustment portion of the screw is capable of being adjusted to fasten the first fastener;
the connecting arm defines a second opening, and the second opening is in communication with the accommodation cavity; the power source is configured to be arranged into the accommodation cavity through the second opening; the second opening is in communication with the second wire passage, and the second opening is in communication with the accommodation groove; the nut is configured to be arranged into the accommodation groove through the second opening;
the terminal stand further includes a cover; the cover matches the second opening and is detachably arranged on the connecting arm; the cover is capable of sealing the second opening.

In some embodiments, the terminal stand further includes a first rotation pin; the first rotation pin passes through the second connection portion and the second installation protrusion to rotatably arrange the second connection portion on the second installation protrusion;
a first fastener serves as the first rotation pin and is further configured to hold the connecting arm in position relative to the rotating assembly;
the second connection portion includes at least one first connection plate spaced apart; the second installation protrusion includes at least one second connection plate arranged spaced apart; the first fastener is configured to cause an adjacent set of a corresponding first connection plate and a corresponding second connection plate to be in tight contact;
the first fastener includes a nut and a screw that are configured to be cooperatively engaged; in a case where the second connection portion rotates relative to the second installation protrusion, both the nut and the screw remain stationary relative to the second installation protrusion, or both the nut and the screw remain stationary relative to the second connection portion;
the first connection portion is located between the first installation protrusion and the second installation protrusion, and the first connection portion defines an accommodation groove;
a side of the second installation protrusion close to the first connection portion is arranged with a third protrusion; the third protrusion is accommodated in the accommodation groove, and the third protrusion defines an installation groove; the nut is arranged in the installation groove and accommodated in the accommodation groove; the nut is peripherally fixed relative to the installation groove about the second rotation axis; a head of the screw includes an adjustment portion, and the adjustment portion of the screw is capable of being adjusted to fasten the first fastener;
the connecting arm defines a second opening, and the second opening is in communication with the accommodation cavity; the power source is configured to be arranged into the accommodation cavity through the second opening; the second opening is in communication with the accommodation groove; the third protrusion is configured to be arranged into the accommodation groove through the second opening; the nut is configured to be arranged into the installation groove through the second opening; the second opening is in communication with the second wire passage;
the terminal stand further includes a cover; the cover matches the second opening and is detachably arranged on the connecting arm; the cover is capable of sealing the second opening;
one of the at least one second connection plate is a second connection sub-plate, the second connection sub-plate is adjacent to or in contact with the first connection portion, and the third protrusion is arranged on the second connection sub-plate.

In some embodiments, the driving assembly is arranged on the rotating assembly; the driving assembly includes a driving main body and an output shaft; the output shaft is rotatably arranged on the driving main body, the driving main body is fixed on the rotating assembly, and the output shaft is transmission-connected to the fixing assembly; and the output shaft is rotatable relative to the driving main body, causing the rotating assembly to rotate relative to the fixing assembly about the first rotation axis;
the driving assembly further includes a first gear fixed on the output shaft; the gimbal assembly includes a second gear fixed relative to the fixing assembly; the second gear meshes with the first gear, and the second gear is coaxial with the first rotation axis.

In some embodiments, the gimbal assembly further includes a circuit board assembly arranged on the rotating assembly, and the circuit board assembly is located in the installation space;
the circuit board assembly includes a first circuit board and a second circuit board electrically connected to the first circuit board; the second circuit board or the first circuit board is electrically connected to the driving assembly;
the driving main body has a first end face; the output shaft extends out from the first end face, and the circuit board assembly is located on a side of the driving main body away from the output shaft; the rotating assembly includes a first outer shell, and the first outer shell encloses to define the installation space; the first circuit board and the second circuit board are arranged spaced apart, and the first rotation axis is located between the first circuit board and the second circuit board.

In some embodiments, the gimbal assembly further includes a bearing; the bearing is located within the installation space, and the bearing includes an inner ring, an outer ring, and rolling elements; the inner ring is sleeved on an inner side of the outer ring, and the rolling elements are rollably arranged between the inner ring and the outer ring; wherein,
the inner ring is peripherally fixed relative to the fixing assembly about the first rotation axis; the outer ring is peripherally fixed relative to the rotating assembly about the first rotation axis; the inner ring is unable to be detached from the fixing assembly, and the outer ring is unable be detached from the rotating assembly; or,
the inner ring is peripherally fixed relative to the rotating assembly about the first rotation axis; the outer ring is peripherally fixed relative to the fixing assembly about the first rotation axis; the inner ring is unable to be detached from the rotating assembly, and the outer ring is unable be detached from the fixing assembly.

In some embodiments, the outer ring is sleeved on an inner side of the rotating assembly; the outer ring is peripherally fixed relative to the rotating assembly about the first rotation axis; the gimbal assembly includes a first limiting portion and a second limiting portion; a top end face of the outer ring is configured to bear against the first limiting portion to enable the outer ring to support the rotating assembly; the outer ring is located between the first limiting portion and the second limiting portion, causing the outer ring to be unable to be detached from the rotating assembly; the fixing assembly is sleeved on an inner side of the inner ring; the inner ring is peripherally fixed relative to the fixing assembly about the first rotation axis; the gimbal assembly further includes a third limiting portion and a fourth limiting portion; the third limiting portion is configured to bear against a bottom end face of the inner ring to enable the fixing assembly to support the inner ring; the inner ring is located between the third limiting portion and the fourth limiting portion, causing the inner ring to be unable to be detached from the rotating assembly; or, the rotating assembly is sleeved on an inner side of the inner ring; the inner ring is peripherally fixed relative to the rotating assembly about the first rotation axis; the gimbal assembly includes a first limiting portion and a second limiting portion; a top end face of the inner ring is configured to bear against the first limiting portion to enable the inner ring to support the rotating assembly; the inner ring is located between the first limiting portion and the second limiting portion, causing the inner ring to be unable to be detached from the rotating assembly; the outer ring is sleeved on an inner side of the fixing assembly; the outer ring is peripherally fixed relative to the fixing assembly about the first rotation axis; the gimbal assembly further includes a third limiting portion and a fourth limiting portion; the third limiting portion is configured to bear against a bottom end face of the outer ring to enable the fixing assembly to support the inner ring; the outer ring is located between the third limiting portion and the fourth limiting portion, causing the outer ring to be unable to be detached from the fixing assembly.

In some embodiments, the connecting arm includes a connection main body; the power source is located within the connection main body; both the connection main body and the power source are columnar, and a cross-sectional area of the power source is greater than or equal to 50% of a cross-sectional area of the connection main body; the power source and the connection main body extend in a same direction, and a length of the power source is greater than or equal to 50% of a length of the connection main body.

In some embodiments, the rotating assembly includes a first outer shell, and the first outer shell encloses to define the installation space; the connecting arm is arranged on the first outer shell.

In some embodiments, the connecting arm is rotatably arranged on the rotating assembly, and the connecting arm is foldable against the gimbal assembly.

In some embodiments, the connecting arm is capable of being held in position relative to the rotating assembly; the connecting arm is rotatably arranged on the rotating assembly about a second rotation axis, and an angle between the second rotation axis and the first rotation axis is greater than or equal to 75 degrees and less than or equal to 90 degrees.

In some embodiments, the terminal stand further includes an accessory; the accessory is arranged on the rotating assembly and is in an exposed state relative to the rotating assembly; in a case where the connecting arm is folded against the rotating assembly, the connecting arm obscures the accessory.

In some embodiments, the support member includes a first support sub-portion and a support rod; the first support sub-portion is arranged on the support rod, and the first support sub-portion is configured to be held by a user;
an outer side wall of the first support sub-portion is a cylindrical surface or an approximately cylindrical surface; an outer side wall of the gimbal assembly is a cylindrical surface or an approximately cylindrical surface; an end of the gimbal assembly is connected to or close to an end of the first support sub-portion; the first support sub-portion and the gimbal assembly together form a first support structure; during rotation of the rotating assembly relative to the fixing assembly about the first rotation axis, the first support structure remains bar-shaped, and the first support structure is capable of being placed horizontally on a support surface; in a case where the first support structure is placed horizontally on the support surface, an angle between the first rotation axis and the support surface is less than or equal to 3 degrees.

In some embodiments, the support rod is a length-adjustable rod; the length-adjustable rod is extendable to cause the gimbal assembly to move away from the first support sub-portion, and the length-adjustable rod is retractable to cause the gimbal assembly to be connected to or close to the first support sub-portion;
the approximately cylindrical surface is capable of being placed horizontally on the support surface, and in a case where the approximately cylindrical surface rolls arbitrarily on the support surface, the angle between the first rotation axis and the support surface is less than or equal to 3 degrees.

In some embodiments, the first support structure includes a first support main body and the rotating component adjacent to or in contact with the first support main body. The first support main body includes the first support portion and the fixed component. The outer side wall of the first support main body is a revolving port coaxial with the first rotation axis. The outer side wall of the rotating component is a revolving port coaxial with the first rotation axis. The overall outer side wall of the first support structure is a revolving port coaxial with the first rotation axis.

In some embodiments, in a case where the first support structure is placed horizontally on the support surface, the angle between the first rotation axis and the support surface is less than or equal to 1 degree.

In some embodiments, the support member includes at least three feet, at least three connecting rods, a sliding sleeve, and a support rod;
wherein the at least three connecting rods correspond to the at least three feet in a one-to-one correspondence; an end of each connecting rod is rotatably connected to the support rod, and another end of the connecting rod is rotatably connected to a corresponding foot; each foot is rotatably connected to the sliding sleeve, and the sliding sleeve is sleeved on the support rod;
in a case where the sliding sleeve slides relative to the support rod, the at least three feet are splayed or folded relative to the support rod;
after the at least three feet are splayed, the at least three feet is capable of supporting on a support surface;
after the at least three feet are folded, the at least three feet, the at least three connecting rods, and the sliding sleeve form a first support sub-portion, and the first support sub-portion is configured to be held by a user
the support rod is a length-adjustable rod.

In some embodiments, the gimbal assembly further includes a locking assembly; the locking assembly includes a first locking member and a second locking member; the first locking member is movably arranged on the rotating assembly, and the second locking member is fixedly arranged on the fixing assembly; the first locking member is rotatable relative to the rotating assembly to cause the first locking member and the second locking member to be in locking engagement or disengaged; in a case where the first locking member and the second locking member are in locking engagement, the rotating assembly is fixed relative to the fixing assembly about the first rotation axis; in a case where the first locking member and the second locking member are disengaged, the rotating assembly is rotatable relative to the fixing assembly about the first rotation axis;
the first locking member is slidably arranged on the rotating assembly;
the rotating assembly includes a first outer shell, and the first outer shell encloses to define the installation space; the driving assembly is located in the installation space, and the first outer shell defines a toggle groove;
the first locking member includes a toggle protrusion; the toggle protrusion is configured to be adjusted by a user to cause the first locking member and the second locking member to be in locking engagement or disengaged; the toggle groove serves as a movement space for the toggle protrusion.

In some embodiments, the connection arm is rotatably arranged on the first outer shell of the rotating assembly, and the connection arm is foldable against the first outer shell; in a case where the connection arm is folded against the first outer shell, the connection arm obscures the toggle protrusion.

### BRIEF DESCRIPTION OF THE DRAWINGS

To more clearly illustrate the technical solutions in the embodiments of the present disclosure or the related art, the following will briefly introduce the drawings required for describing the embodiments or the related art. Obviously, the drawings in the following description are merely some embodiments of the present disclosure. For those skilled in the art, other drawings may be obtained from these drawings without creative effort.

FIG. 1 is a schematic structural diagram of a terminal stand according to some embodiments of the present disclosure in a stored state.

FIG. 2 is a schematic structural diagram of the terminal stand shown in FIG. 1 with a support member hidden.

FIG. 3 is a front view of the structure shown in FIG. 2 in a certain direction.

FIG. 4 is a cross-sectional view taken along line A-A of the structure shown in FIG. 3.

FIG. 5 is a top view of the structure shown in FIG. 3.

FIG. 6 is a cross-sectional view taken along line B-B of the structure shown in FIG. 5.

FIG. 7 is an enlarged view of portion D in the structure shown in FIG. 6.

FIG. 8 is an enlarged view of portion E in the structure shown in FIG. 6.

FIG. 9 is a cross-sectional view taken along line C-C of the structure shown in FIG. 5.

FIG. 10 is an enlarged view of portion F in the structure shown in FIG. 9.

FIG. 11 is an enlarged view of portion G in the structure shown in FIG. 9.

FIG. 12 is a schematic structural diagram of the structure shown in FIG. 2 with a cover hidden.

FIG. 13 is an enlarged view of portion H in the structure shown in FIG. 12.

FIG. 14 is a schematic structural diagram of a connecting arm in the structure shown in FIG. 12.

FIG. 15 is a schematic structural diagram of the cover in the structure shown in FIG. 2.

FIG. 16 is a schematic structural diagram of a first outer shell in the structure shown in FIG. 12.

FIG. 17 is a schematic structural diagram of the first outer shell shown in FIG. 16 from another angle.

FIG. 18 is a schematic structural diagram of the structure shown in FIG. 12 with the first outer shell hidden.

FIG. 19 is a schematic structural diagram of the structure shown in FIG. 12 with a first outer shell, a holding member, a connecting arm, a first inner shell, a mounting base, and other parts hidden.

FIG. 20 is a schematic structural diagram of the structure shown in FIG. 18 with a circuit board assembly, a holding member, a connecting arm, and other parts hidden.

FIG. 21 is a schematic structural diagram of the structure shown in FIG. 20 with a driving main body, an output shaft, and other parts hidden.

FIG. 22 is a schematic structural diagram of the structure shown in FIG. 21 from another angle.

FIG. 23 is a schematic structural diagram of a first inner shell and a mounting base in the structure shown in FIG. 21.

FIG. 24 is a schematic structural diagram of the structure shown in FIG. 23 from another angle.

FIG. 25 is a schematic structural diagram of a first locking member in the structure shown in FIG. 22.

FIG. 26 is a schematic structural diagram of the first locking member shown in FIG. 25 with a toggle protrusion hidden.

FIG. 27 is a schematic structural diagram of a toggle protrusion in the first locking member shown in FIG. 25.

FIG. 28 is a schematic structural diagram of the structure shown in FIG. 21 with a first inner shell, a mounting base, and other parts hidden.

FIG. 29 is a schematic structural diagram of a second inner shell in the structure shown in FIG. 28.

FIG. 30 is a schematic structural diagram of the second inner shell shown in FIG. 29 from another angle.

FIG. 31 is a schematic structural diagram of the structure shown in FIG. 28 with a second inner shell hidden.

FIG. 32 is a schematic structural diagram of the structure shown in FIG. 31 with a fixing assembly, a bearing, a sixth fastener, and other parts hidden.

FIG. 33 is a schematic structural diagram of the structure shown in FIG. 32 from another angle.

FIG. 34 is a schematic structural diagram of a fixing assembly and a sixth fastener in the structure shown in FIG. 31.

FIG. 35 is a schematic structural diagram of one usage state of the terminal stand shown in FIG. 1.

FIG. 36 is a schematic diagram showing the cooperation of a foot, a support rod, a sliding sleeve, and a connecting rod in the terminal stand shown in FIG. 35.

### DETAILED DESCRIPTION

The present disclosure will be further described in detail below with reference to the accompanying drawings. The specific embodiments are merely an explanation of the present disclosure and not a limitation thereof. Those skilled in the art can make modifications to the embodiments as needed after reading this description without making creative contributions, but as long as they fall within the scope of the claims of the present disclosure, they are protected by the patent law.

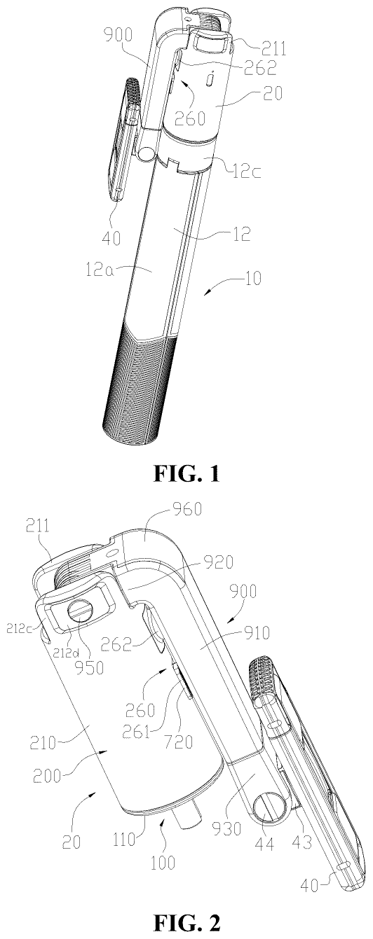

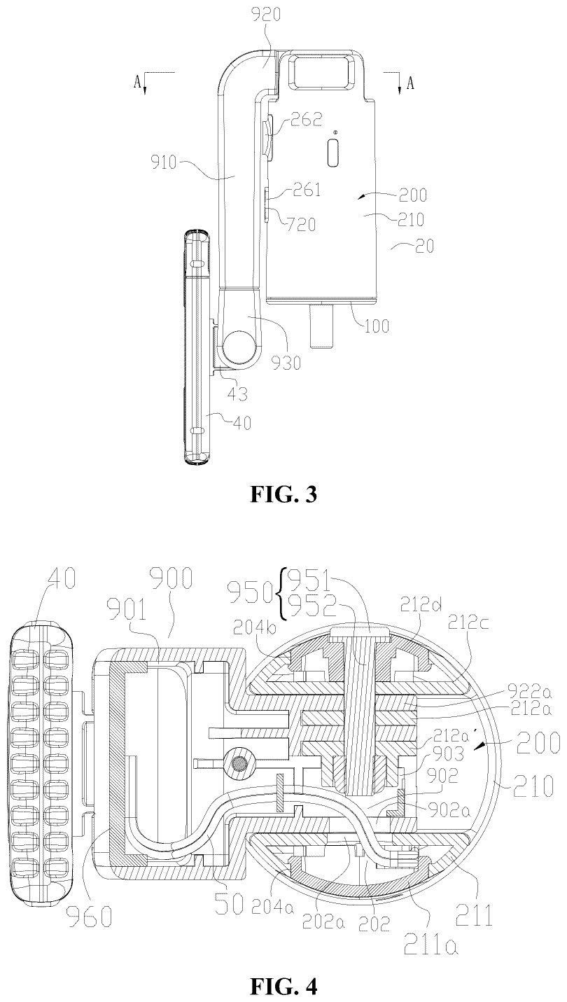

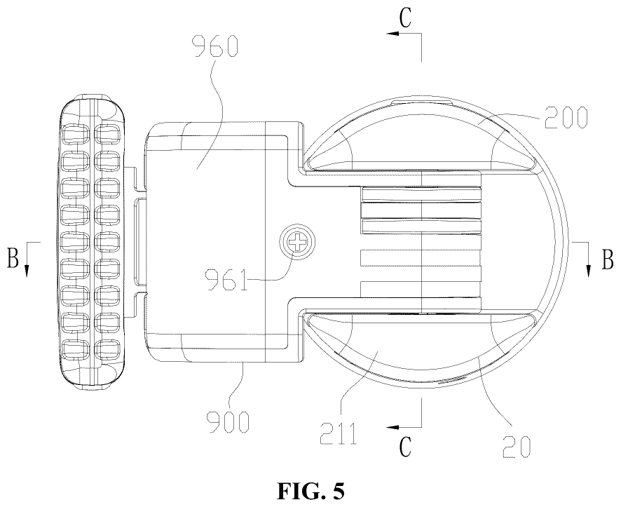

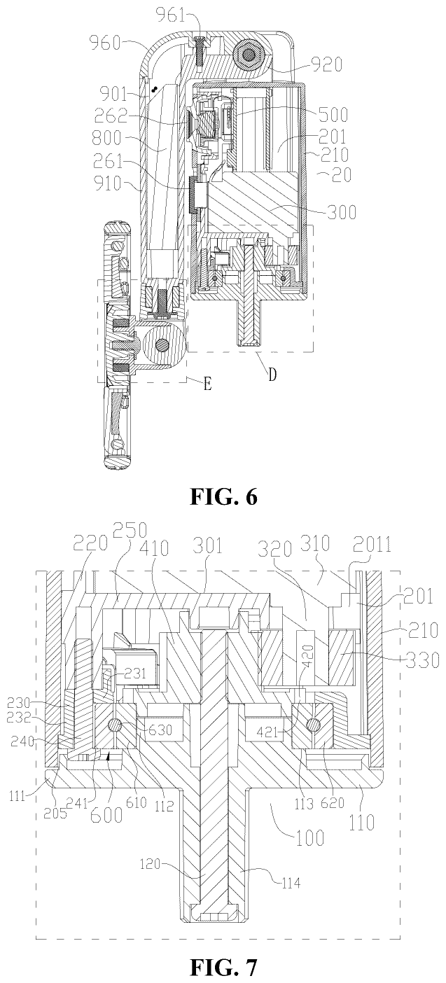

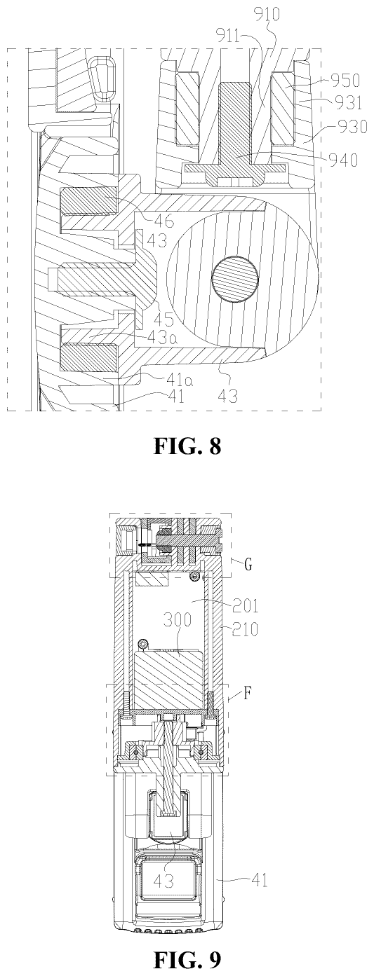

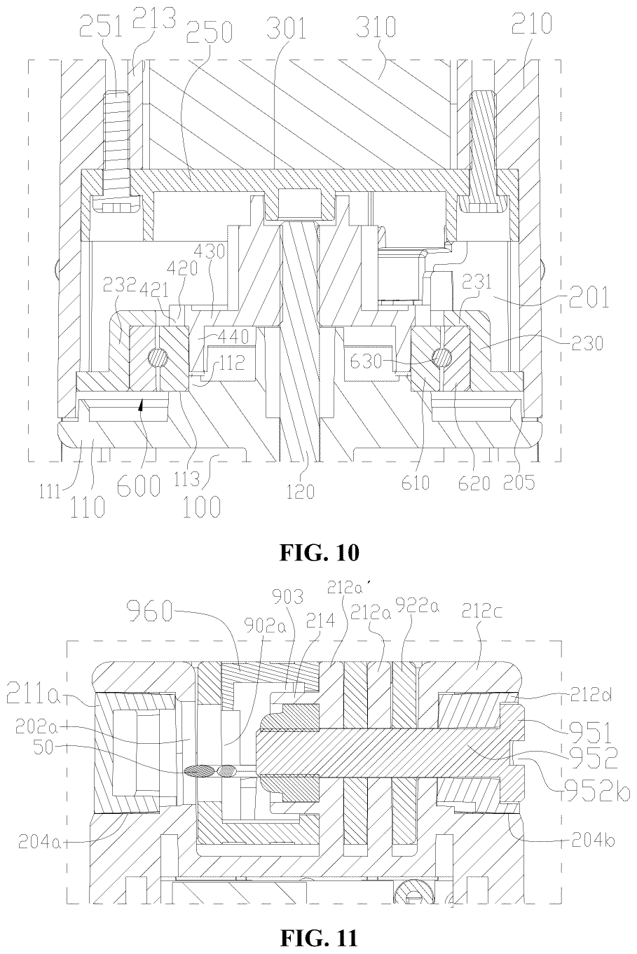

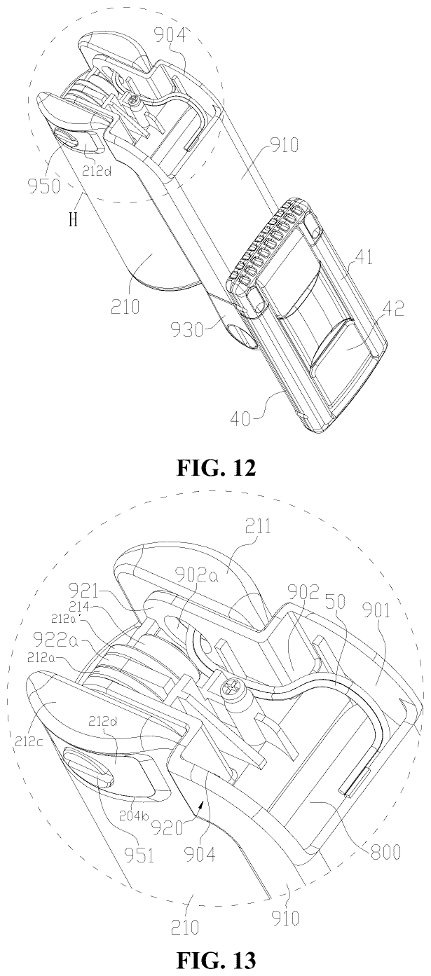

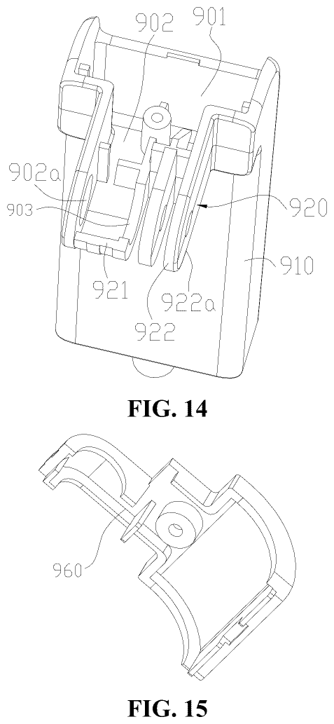

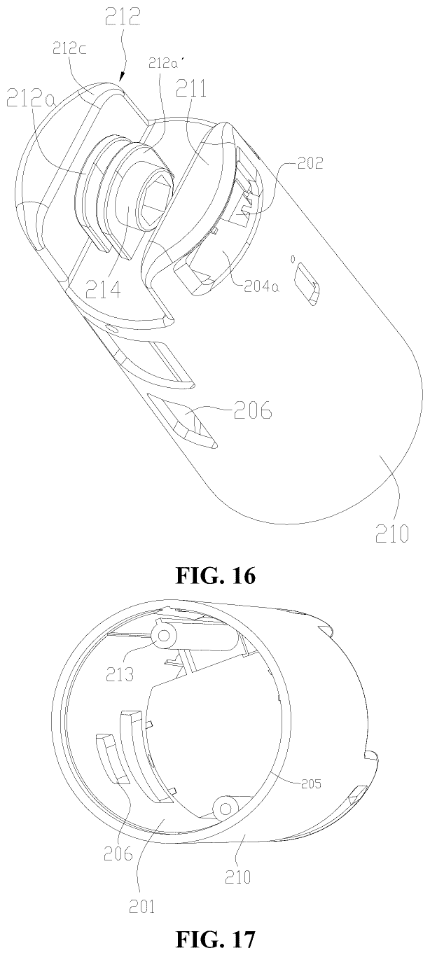

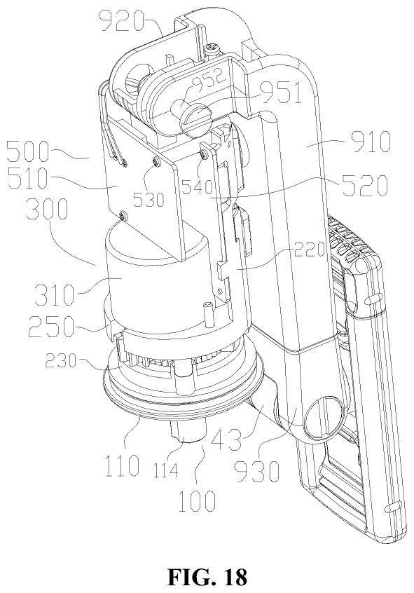

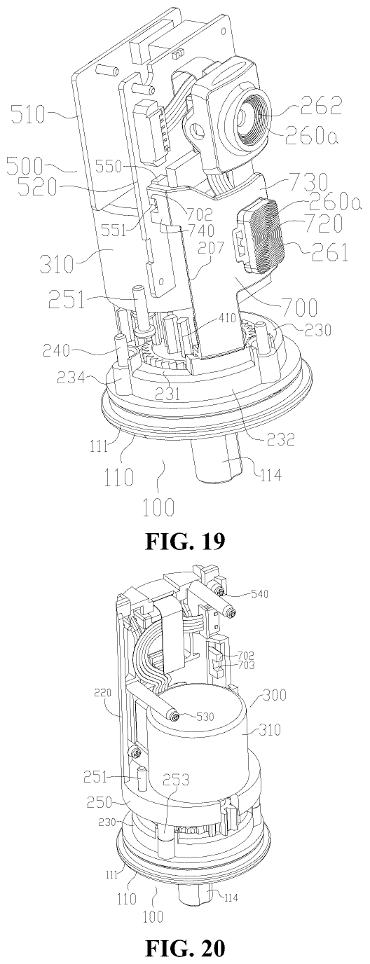

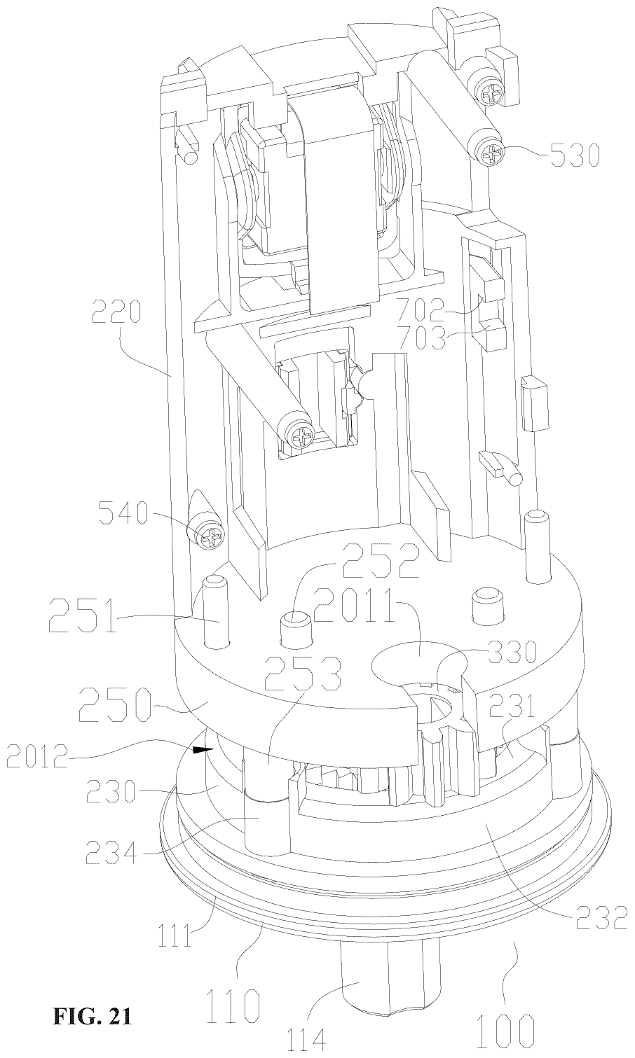

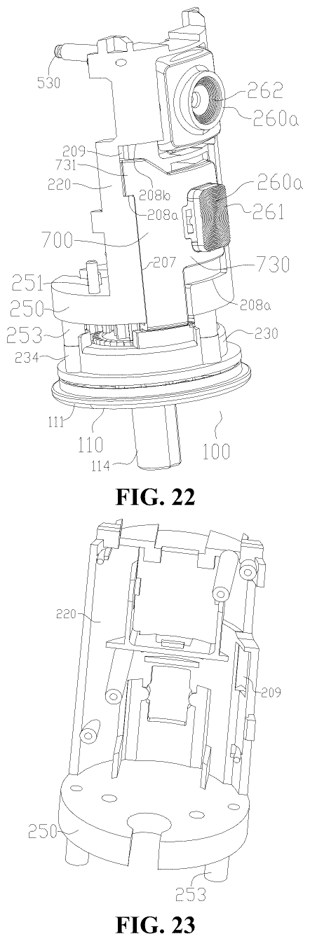

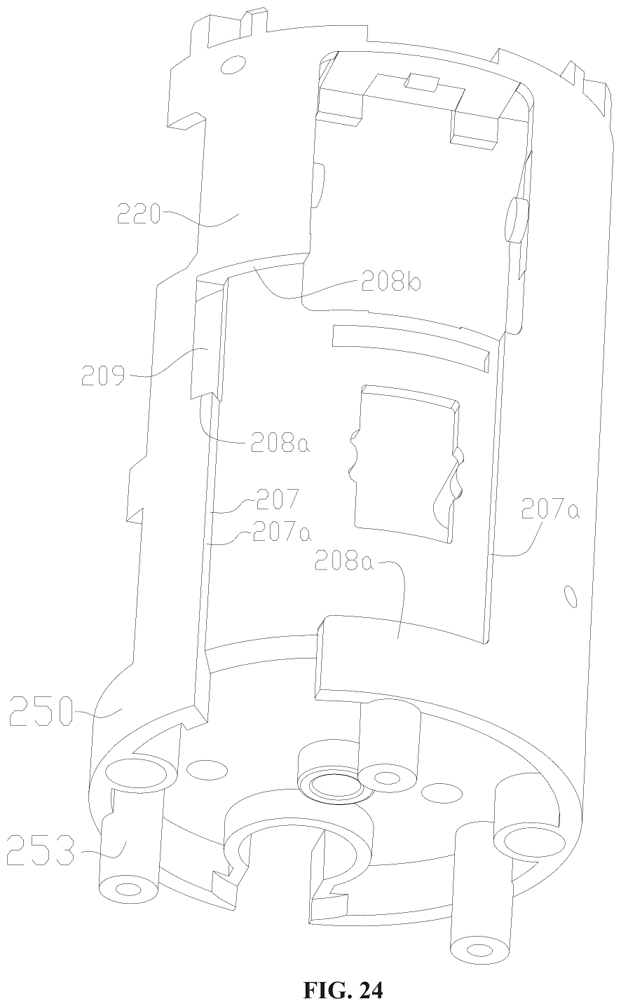

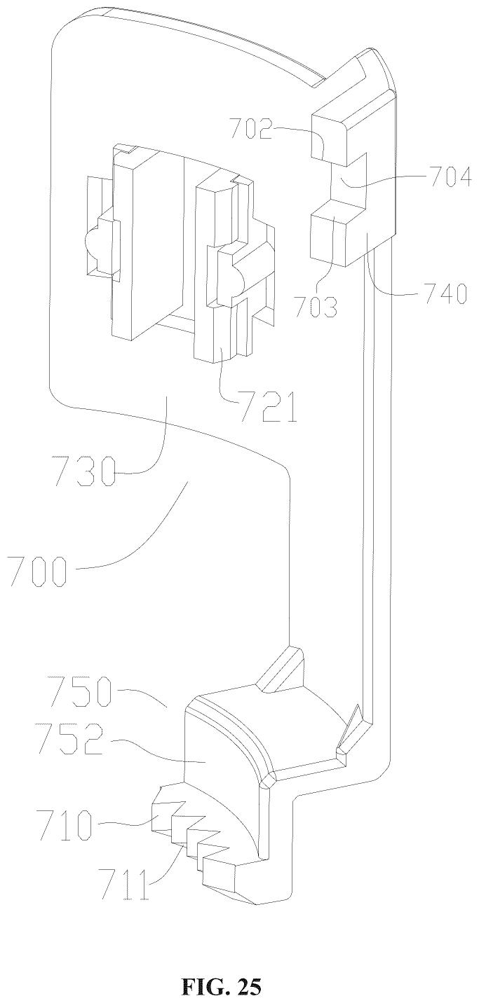

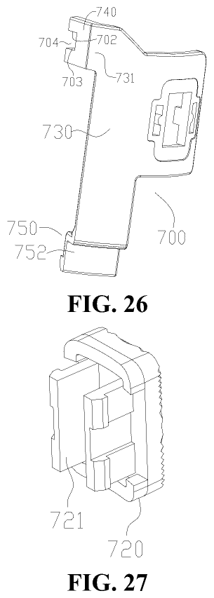

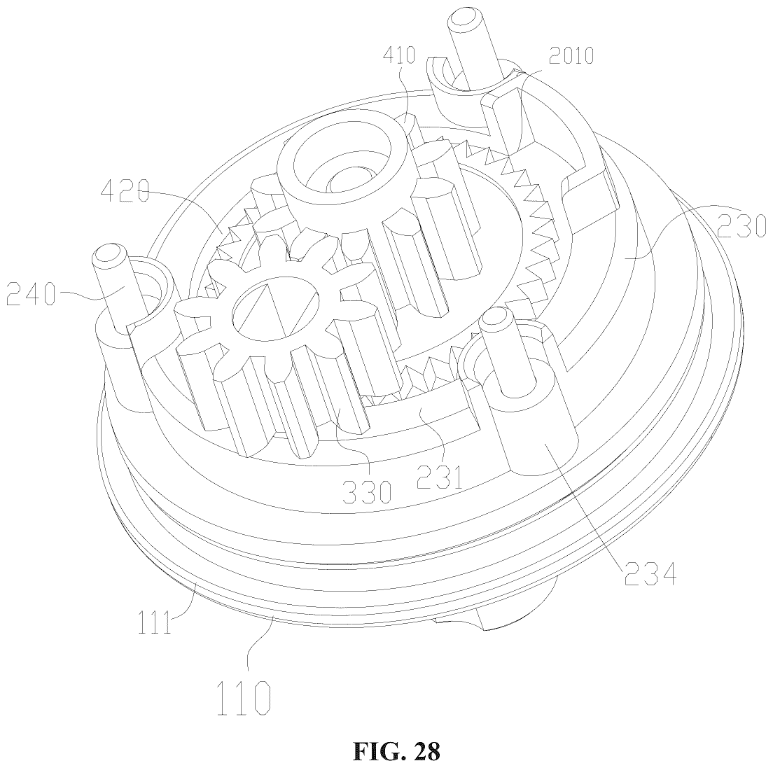

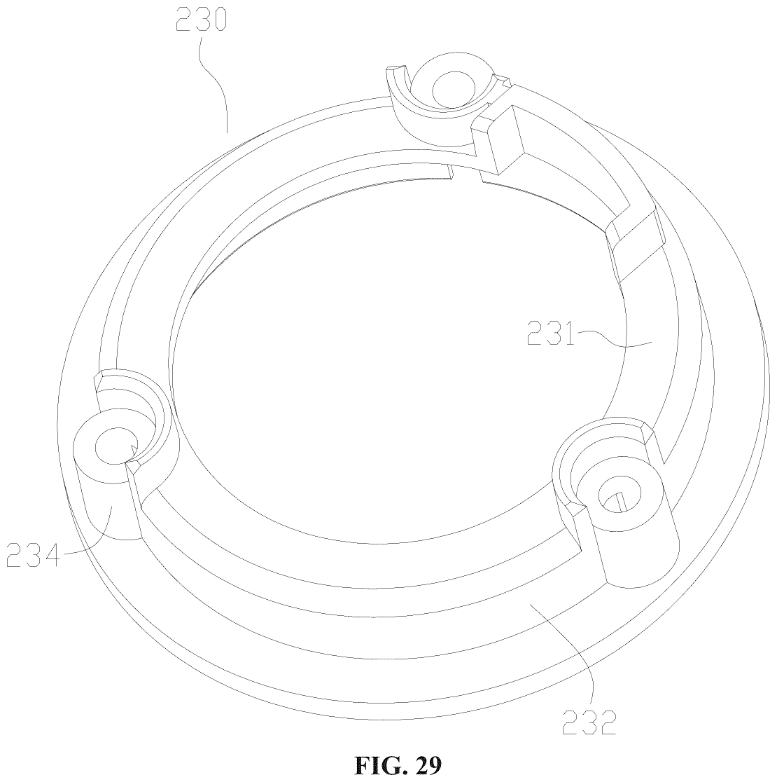

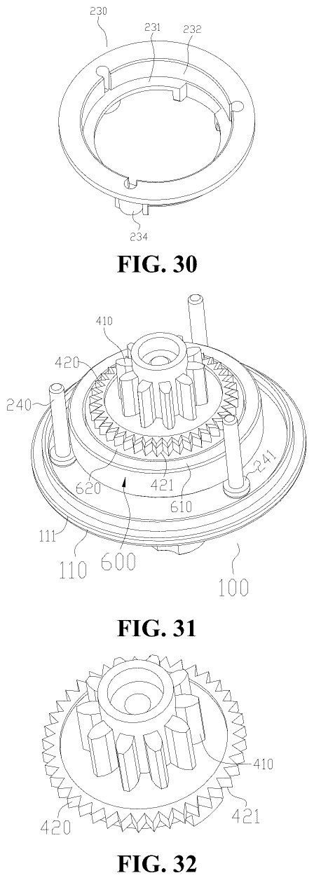

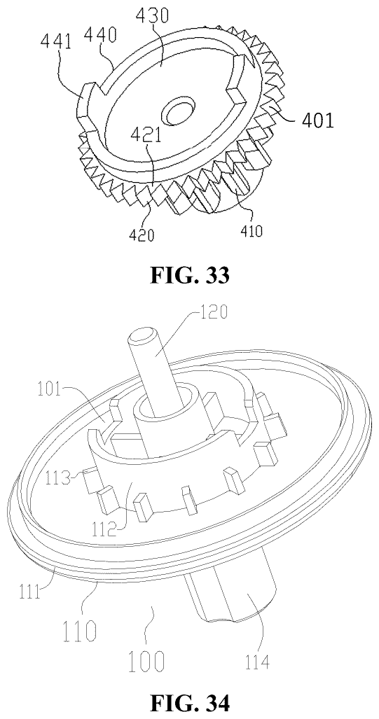

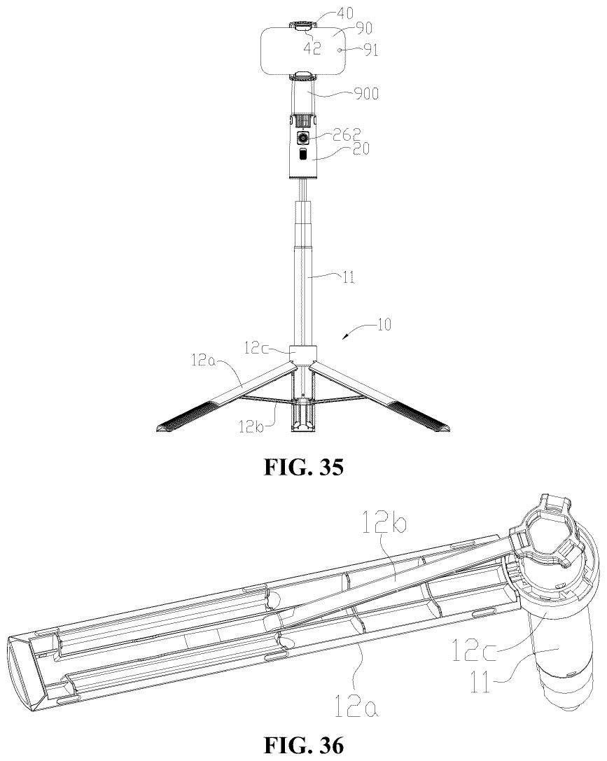

Referring to FIGS. 1-36, some embodiments of the present disclosure provide a terminal stand, including a support member 10, a gimbal assembly 20, a connecting assembly, and a holding member 40. The support member 10 is configured to support the gimbal assembly 20, the connecting assembly, and the holding member 40. The gimbal assembly 20 includes a fixing assembly 100, a rotating assembly 200, and a driving assembly 300. The rotating assembly 200 is rotatable relative to the fixing assembly 100 about a first rotation axis. The gimbal assembly 20 defines an installation space 201. The driving assembly 300 is arranged within the installation space 201 and is configured to drive the rotating assembly 200 to rotate relative to the fixing assembly 100. The fixing assembly 100 is arranged on the support member 10. The connecting assembly includes a connecting arm 900 and a power source 800. The connecting arm 900 is arranged on the rotating assembly 200 and defines an accommodation cavity 901. The power source 800 is arranged within the accommodation cavity 901 and is electrically connected to the driving assembly 300. The holding member 40 is arranged on the connecting arm 900 and is configured to hold an electronic terminal 90.

In the terminal stand of the above embodiments of the present disclosure, the power source 800 is arranged in the connecting arm 900 of the terminal stand, such that the power source 800 is positioned outside the gimbal assembly 20. This means the gimbal assembly 20 does not need to reserve extra space for the power source 800, thereby reducing the volume occupied by the gimbal assembly 20. The gimbal assembly 20 is more proportionate in size to other parts of the terminal stand, thus facilitating the storage of the terminal stand. Furthermore, the power source 800 is arranged in the connecting arm 900 of the terminal stand, thereby preventing potential damage to the gimbal assembly 20 caused by power source swelling, for example, interference between the rotating assembly 200 and the fixing assembly 100 caused by swelling of the power source 800 may be avoided.

For example, the support member 10 may be supported (i.e. standing) on a supported surface (such as a desktop, the ground, etc.). This supported surface may be a supported plane or a supported curved surface. The support member 10 may have a support plate, or the support member 10 may have at least three feet 12a.

For example, the support member 10 may be adsorbed onto an adsorbed surface (such as a desktop, car glass surface, wall surface, car center console surface, etc.). The support member 10 has a suction cup portion, and the support member 10 may be adsorbed onto the support surface.

For example, the support member 10 may be magnetically attracted to a magnetically attracted surface (such as an iron surface, etc.). The magnetically attracted surface has ferromagnetic or permanent magnetic properties. The support member 10 has a magnetic attraction portion made of permanent magnetic material.

For example, the support member 10 may be clamped to a clamped object (such as a tabletop, railing, bedhead, chair armrest, etc.). The support member 10 includes a clamping portion 42. The clamped object may be a plate-like object or a rod-like object.

For example, the support member 10 may have a support rod 11 to support the electronic terminal 90 at a certain height or angle. The fixing assembly 100 is arranged on the support rod 11. For example, the support rod 11 is a length-adjustable rod, or the support rod 11 is a flexible rod.

For example, the fixing assembly 100 may be fixedly arranged on the support member 10, or the fixing assembly 100 may be movably arranged on the support member 10.

For example, the rotating assembly 200 may be directly rotatably arranged on the fixing assembly 100, or the rotating assembly 200 may be indirectly rotatably arranged on the fixing assembly 100.

For example, the installation space 201 may be located in the rotating assembly 200, or the installation space 201 may be located in the fixing assembly 100, or the rotating assembly 200 and the fixing assembly 100 together enclose to define the installation space 201.

For example, the driving assembly 300 may be a motor, such as a brushed motor, brushless motor, stepper motor, etc.

For example, the driving assembly 300 is arranged on the rotating assembly 200. For instance, the driving assembly 300 includes a driving main body 310 and an output shaft 320. The output shaft 320 extends from the driving main body 310 and can rotate relative to the driving main body 310. The driving main body 310 is arranged on the rotating assembly 200. The output shaft 320 is coaxial with the first rotation axis and is peripherally fixed to the fixing assembly 100. When the output shaft 320 rotates, the rotating assembly 200 rotates relative to the fixing assembly 100. Alternatively, the output shaft 320 is not coaxial with the first rotation axis; the output shaft 320 is transmission-connected to the fixing assembly 100 through a transmission component (such as gears, friction wheels, etc.), and when the output shaft 320 rotates, the rotating assembly 200 rotates relative to the fixing assembly 100.

For example, the driving assembly 300 is arranged on the fixing assembly 100. For instance, the driving main body 310 of the driving assembly 300 is arranged on the fixing assembly 100. The output shaft 320 is coaxial with the first rotation axis, and the output shaft 320 of the driving assembly 300 is peripherally fixed to the rotating assembly 200. When the output shaft 320 rotates, the rotating assembly 200 rotates relative to the fixing assembly 100. Alternatively, the output shaft 320 is not coaxial with the first rotation axis; the output shaft 320 is transmission-connected to the rotating assembly 200 through a transmission component (such as gears, friction wheels, etc.), and when the output shaft 320 rotates, the rotating assembly 200 rotates relative to the fixing assembly 100.

For example, the control method of the driving assembly 300 may be simply adopted with switch control. When the user turns on the switch, the driving assembly 300 operates; when the user turns off the switch, the driving assembly 300 stops operating.

For example, the driving assembly 300 may be controlled by a follow-shot chip. The follow-shot chip is electrically connected to a tracking camera 262 and to the driving assembly 300. The follow-shot chip is configured to process the images from the tracking camera 262 to control the driving assembly 300 to drive the rotating assembly 200 such that the tracked person or object remains in the center of the frame of the tracking camera's image. The electronic terminal 90 includes a shooting lens 91. When the terminal stand is in a follow-shot state, the shooting lens 91 can capture the tracked person or object (the shooting lens 91 may be the tracking camera 262, or the shooting lens 91 and the tracking camera 262 may be different lenses).

For example, the fixing assembly 100 may be detachably arranged on the support member 10, or the fixing assembly 100 may be non-detachably (i.e., fixedly) arranged on the support member 10.

For example, when the support member 10 includes a support rod 11, the fixing assembly 100 may be arranged on a top end of the support rod 11.

For example, the connecting arm 900 is configured to carry the holding member 40. The connecting arm 900 can extend the holding member 40 a certain distance relative to the support member 10, making the electronic terminal 90 easier to use for shooting or other purposes.

For example, the connecting arm 900 may be fixedly arranged on the rotating assembly 200, or the connecting arm 900 may be rotatably arranged on the rotating assembly 200.

For example, the power source 800 and the driving assembly 300 are connected by a connecting wire 50. The installation method of the connecting wire 50 may be exposed wiring or concealed wiring.

For example, the electronic terminal 90 may be a mobile phone, tablet, etc.

For example, the holding member 40 may be fixedly arranged on the connecting arm 900, or the holding member 40 may be movably arranged on the connecting arm 900.

For example, the holding member 40 may be a fixture 40 for holding the electronic terminal 90. The fixture 40 includes a clamp body 41 and two clamping portions 42. The two clamping portions 42 clamp on two opposite sides of the electronic terminal 90, respectively. The clamp body 41 can elastically expand and contract to adjust the clamping width of the fixture 40. The clamping portions 42 can be retracted into the clamp body 41.

For example, the holding member 40 is a suction cup for adsorbing the electronic terminal 90. For instance, the suction cup can adhere to a back of the electronic terminal 90.

For example, the holding member 40 is a magnetic attraction member for magnetically holding the electronic terminal 90. The magnetic attraction member may be an electromagnet or a permanent magnet.

For example, the holding member 40 is a tray for supporting the electronic terminal 90. The electronic terminal 90 is placed on the tray.

For example, the holding member 40 is a catching member for securing the electronic terminal 90. The catching member is configured to catch and hold the electronic terminal 90.

In some implementations, the driving assembly 300 is arranged on the rotating assembly 200. The connecting arm 900 is rotatably arranged on the rotating assembly 200 about a second rotation axis. The terminal stand includes a connecting wire 50. An end of the connecting wire 50 extends into the accommodation cavity 901, and the other end of the connecting wire 50 extends into the installation space 201. The connecting wire 50 is configured to supply power from the power source 800 to the driving assembly 300. The rotating assembly 200 is arranged with a first wire passage channel 202 for the connecting wire 50 to pass through. The first wire passage channel 202 is in communication with the installation space 201. The connecting arm 900 is arranged with a second wire passage channel 902 for the connecting wire 50 to pass through. The second wire passage channel 902 is in communication with the first wire passage channel 202. The second wire passage channel 902 is in communication with the accommodation cavity 901. During the rotation of the connecting arm 900 relative to the rotating assembly 200 about the second rotation axis, the first wire passage channel 202 and the second wire passage channel 902 remain communicated to facilitate the passage of the connecting wire 50 through the first wire passage channel 202 and the second wire passage channel 902.

It can be understood that during the rotation of the connecting arm 900 relative to the rotating assembly 200 about the second rotation axis, the first wire passage channel 202 and the second wire passage channel 902 remain communicated, ensuring that the connecting wire 50 does not interfere with the rotating assembly 200 or the connecting arm 900. On one hand, this may prevent the connecting wire 50 from affecting the rotation of the connecting arm 900 relative to the rotating assembly 200; on the other hand, it may also prevent the connecting arm 900 from damaging the connecting wire 50 during its rotation relative to the rotating assembly 200.

It can be understood that during the rotation of the connecting arm 900 relative to the rotating assembly 200 about the second rotation axis, neither the first wire passage channel 202 nor the second wire passage channel 902 will cause destructive crushing of the connecting wire 50.

It can be understood that during the rotation of the connecting arm 900 relative to the rotating assembly 200 about the second rotation axis, the connecting wire 50 can always pass through the first wire passage channel 202 and the second wire passage channel 902.

For example, the installation space 201 is located within the rotating assembly 200.

For example, the first wire passage channel 202 includes a first wire port 202a near the second wire passage channel 902. The second wire passage channel 902 includes a second wire port 902a near the first wire passage channel 202. The first wire port 202a and the second wire port 902a are connected to or close to each other. Perpendicular to the second rotation axis, there is a second projection plane defined. The projection of the first wire port 202a on the second projection plane is a first port projection. The projection of the second wire port 902a on the second projection plane is a second port projection. During the rotation of the connecting arm 900 relative to the rotating assembly 200 about the second rotation axis, the first port projection and the second port projection are always intersected. Alternatively, during this rotation process, the first port projection encompasses the second port projection. Alternatively, during this rotation process, the second port projection encompasses the first port projection.

In some implementations, the first wire passage channel 202 includes a first wire port 202a near the second wire passage channel 902. The second wire passage channel 902 includes a second wire port 902a near the first wire passage channel 202. The first wire port 202a and the second wire port 902a are connected to or close to each other. Both the first wire port 202a and the second wire port 902a are revolving ports, and both are coaxial with the second rotation axis.

It can be understood that the coaxial arrangement of the first wire port 202a and the second wire port 902a ensures that during the rotation of the connecting arm 900 relative to the rotating assembly 200, the first wire port 202a and the second wire port 902a remain communicated, and the cross-sectional area of the passage between them remains constant.

It can be understood that the first wire port 202a refers to an opening at one end of the first wire passage channel 202, and the second wire port 902a refers to an opening at one end of the second wire passage channel 902.

For example, the revolving port may be a cylindrical port, conical port, spherical port, etc.

In other implementations, the first wire port 202a is a non-revolving port, and the second wire port 902a is a non-revolving port.

In some implementations, the rotating assembly 200 includes a first installation protrusion 211 and a second installation protrusion 212 that are spaced apart. The first wire passage channel 202 extends to the first installation protrusion 211. The connecting arm 900 includes a connection protrusion 920. The connection protrusion 920 includes a first connection portion 921 and a second connection portion 922 that are arranged side by side. The second wire passage channel 902 extends to the first connection portion 921. The first connection portion 921 is connected to or close to the first installation protrusion 211, thereby connecting the first wire passage channel 202 and the second wire passage channel 902. The second connection portion 922 is rotatably arranged on the second installation protrusion 212, thereby enabling the connecting arm 900 to be rotatably arranged on the rotating assembly 200.

It can be understood that the connection protrusion 920 serves both to facilitate the passage of the connecting wire 50 and to achieve the rotational connection between the connecting arm 900 and the rotating assembly 200, making the structure of the terminal stand compact.

It can be understood that the first wire port 202a is located on the first installation protrusion 211, and the second wire port 902a is located on the first connection portion 921.

It can be understood that the second connection portion 922 is rotatably arranged on the second installation protrusion 212 about the second rotation axis.

For example, the connecting arm 900 includes a connection main body 910 and the connection protrusion 920. The connection protrusion 920 protrudes from an end of the connection main body 910. The connection main body 910 can be folded against the gimbal assembly 20.

For example, both the first installation protrusion 211 and the second installation protrusion 212 are disposed on a first outer shell 210.

For example, the connecting arm 900 further includes a first connection head 930. The first connection head 930 is rotatably connected to the other end of the connection main body 910 about a fourth rotation axis. The first connection head 930 and the connection protrusion 920 are located at the two ends of the connection main body 910, respectively. The angle between the fourth rotation axis and a line parallel to the extension direction of the connection main body 910 is 0-15°. In some embodiments, the fourth rotation axis is parallel to the extension direction of the connection main body 910. The fixture 40 is arranged on the first connection head 930. When the first connection head 930 rotates about the fourth rotation axis, the usage orientation of the electronic terminal 90 can be adjusted.

For example, to prevent the fixture 40 from interfering with the folding of the connection main body 910 against the rotating assembly 200, rotating the first connection head 930 can position the fixture 40 and the connection protrusion 920 on opposite sides of the connection main body 910.

In other implementations, to prevent the fixture 40 from interfering with the folding of the connection main body 910 against the rotating assembly 200, when the connection main body 910 is folded against the rotating assembly 200, there is sufficient clearance between the first connection head 930 and the rotating assembly 200 to accommodate the fixture 40.

For example, the first connection head 930 can be held in position relative to the connection main body 910. The first connection head 930 can be held in position relative to the connection main body 910 by the user's hand force. Alternatively, the first connection head 930 and the connection main body 910 have a direct or indirect interference fit, enabling the first connection head 930 to be held in position relative to the connection main body 910. Alternatively, the first connection head 930 can be locked to the connection main body 910; for instance, the first connection head 930 is fastened to the connection main body 910 by a fastener, or the first connection head 930 is engaged with the connection main body 910 by a catching structure. The fastener may be a threaded fastener or a rivet. Alternatively, the first connection head 930 is rotatably mounted to the connection main body 910 with damping; for example, a damping ring is arranged between the first connection head 930 and the connection main body 910. The damping ring may be made of a flexible material. As another example, the first connection head 930 and the connection main body 910 are in direct or indirect frictional contact, thereby creating frictional damping between the first connection head 930 and the connection main body 910. Frictional damping between the first connection head 930 and the connection main body 910 may be achieved via a fastener, which may be a threaded fastener, rivet, etc. Specifically, the first connection head 930 is rotatably connected to the connection main body 910 via a second rotation pin 940. A tenth fastener serves as the second rotation pin 940, and this tenth fastener 940 may be a threaded fastener or a rivet. The first connection head 930 is arranged with a first rotation portion 931, and the connection main body 910 is arranged with a second rotation portion 911. A first damping ring 950 is arranged between the first rotation portion 931 and the second rotation portion 911. The first damping ring 950 provides rotational damping between the first rotation portion 931 and the second rotation portion 911. The first rotation portion 931 is a protrusion and the second rotation portion 911 is a recess, or conversely, the first rotation portion 931 is a recess and the second rotation portion 911 is a protrusion.

For example, the fixture 40 is rotatably arranged on the connecting arm 900 about a fifth rotation axis to adjust the usage direction of the electronic terminal 90. The angle between the fifth rotation axis and the fourth rotation axis is 75°-90°, and in some embodiments, the angle is 90°. Specifically, the fixture 40 includes a second connection head 43, which is rotatably arranged on the first connection head 930 about the fifth rotation axis. Merely as an example, a sixth rotation axis is parallel to a display surface of the electronic terminal 90, or perpendicular to the lens axis of the electronic terminal 90.

It can be understood that the fixture 40 may be held in position relative to the first connection head 930. More specifically, the second connection head 43 may be held in position relative to the first connection head 930. For example, the second connection head 43 may be held in position relative to the first connection head 930, which may be achieved by the user's hand force keeping the second connection head 43 in position relative to the first connection head 930. Alternatively, the second connection head 43 and the first connection head 930 may have a direct or indirect interference fit, enabling the second connection head 43 to be held in position relative to the first connection head 930. Alternatively, the second connection head 43 may be locked to the first connection head 930. For instance, the second connection head 43 is fastened to the first connection head 930 by a fastener, or the second connection head 43 is engaged with the first connection head 930 by a catching structure. The fastener may be a threaded fastener or a rivet. Alternatively, the second connection head 43 is rotatably mounted to the first connection head 930 with damping. For example, a damping ring may be arranged between the second connection head 43 and the first connection head 930. The damping ring may be made of a flexible material. As another example, the second connection head 43 and the first connection head 930 are in direct or indirect frictional contact, thereby creating frictional damping between the second connection head 43 and the first connection head 930. Frictional damping between the second connection head 43 and the first connection head 930 may be achieved via a fastener, which may be a threaded fastener, rivet, etc. Specifically, the rotational connection between the second connection head 43 and the first connection head 930 is achieved via a third rotation pin 44. An eleventh fastener serves as the third rotation pin 44. The eleventh fastener 44 is a rivet or a threaded fastener. The tightening force of the eleventh fastener 44 provides rotational damping between the second connection head 43 and the first connection head 930.

For example, the fixture 40 can rotate relative to the connecting arm 900 about the sixth rotation axis to adjust the usage orientation of the electronic terminal 90. The usage orientation may be horizontal, vertical, oblique, etc. The angle between the sixth rotation axis and a line parallel to the extension direction of the connection main body 910 is 75°-90°. In some embodiments, the sixth rotation axis is perpendicular to the extension direction of the connection main body 910. Merely as an example, the sixth rotation axis is perpendicular to the display surface of the electronic terminal 90, or, the sixth rotation axis is parallel to the lens axis of the electronic terminal 90.

Specifically, the fixture 40 includes the clamp body 41, the clamping portions 42, and the second connection head 43. The second connection head 43 is rotatably arranged on the connecting arm 900 about the sixth rotation axis. The clamp body 41 and clamping portions 42 are for the electronic terminal 90.

Specifically, the clamp main body 41 may be held in position relative to the second connection head 43. The clamp main body 41 may be held in position relative to the second connection head 43. For example, the clamp main body 41 may be held in position relative to the second connection head 43. This may be achieved by the user's hand force keeping the clamp main body 41 in position relative to the second connection head 43. Alternatively, the clamp main body 41 and the second connection head 43 have a direct or indirect interference fit, enabling the clamp main body 41 to be held in position relative to the second connection head 43. Alternatively, the clamp main body 41 may be locked to the second connection head 43; for instance, the clamp main body 41 is fastened to the second connection head 43 by a fastener, or the clamp main body 41 is engaged with the second connection head 43 by a catching structure. The fastener may be a threaded fastener or a rivet. Alternatively, the clamp main body 41 is rotatably mounted to the second connection head 43 with damping; for example, a damping ring is arranged between the clamp main body 41 and the second connection head 43. The damping ring may be made of a flexible material. As another example, the clamp main body 41 and the second connection head 43 are in direct or indirect frictional contact, thereby creating frictional damping between the clamp main body 41 and the second connection head 43. Frictional damping between the clamp main body 41 and the second connection head 43 may be achieved via a fastener, which may be a threaded fastener, rivet, etc. Specifically, the rotational connection between the clamp main body 41 and the second connection head 43 is achieved via a fourth rotation pin 45. A twelfth fastener serves as the fourth rotation pin 45. The twelfth fastener 45 is a rivet or a threaded fastener. The clamp main body 41 is arranged with a third rotation portion 41a. The second connection head 43 is arranged with a fourth rotation portion 43a. A second damping ring 46 is arranged between the third rotation portion 41a and the fourth rotation portion 43a. The second damping ring 46 provides rotational damping between the third rotation portion 41a and the fourth rotation portion 43a. The second damping ring 46 provides rotational damping between the third rotation portion 41a and the fourth rotation portion 43a.

For example, when the fixture 40 is in a certain position relative to the first connection head 930, the first connection head 930 can undergo full 360-degree rotation about the fourth rotation axis. Specifically, when the fixture 40 is elongated and close to the connecting arm 900, and when rotated to an end space of the connection main body 910 (e.g., when the fixture 40 is perpendicular to the connection main body 910), the first connection head 930 can undergo full 360-degree rotation about the fourth rotation axis.

In other examples, when the fixture 40 is in any position relative to the first connection head 930, the first connection head 930 can perform a full 360-degree rotation about the fourth rotation axis. It can be understood that in this case, there is sufficient clearance space between the fixture 40 and the connecting arm 900.

For example, when the first connection head 930 is in a certain position relative to the connection main body 910, the fixture 40 can perform a full 360-degree rotation about the sixth rotation axis. For instance, both the first connection head 930 and the connection main body 910 are plate-shaped, and the cross-section of the first connection head 930 corresponds to (matches with) that of the connection main body 910. The fixture 40 is close to the connecting arm 900. When the first connection head 930 rotates to align with the connection main body 910, the fixture 40 can perform a full 360-degree rotation about the sixth rotation axis.

In other examples, when the first connection head 930 is in any position relative to the connection main body 910, the fixture 40 can perform a full 360-degree rotation about the sixth rotation axis. It can be understood that in this case, there is sufficient clearance space between the fixture 40 and the connecting arm 900.

In some implementations, the connecting assembly further includes a first rotation pin 950. The first rotation pin 950 passes through the second connection portion 922 and the second installation protrusion 212 to rotatably mount the second connection portion 922 on the second installation protrusion 212. A first fastener 950 serves as the first rotation pin 950 and is configured to hold the connecting arm 900 in position relative to the rotating assembly 200.

It can be understood that the first rotation pin 950 is configured both to rotatably mount the second connection portion 922 on the second installation protrusion 212 and to provide a damping force between the second connection portion 922 and the second installation protrusion 212, making the structure of the terminal stand more compact.

It can be understood that the first rotation pin 950 is coaxial with the second rotation axis.

For example, the first fastener 950 is a threaded fastener, rivet, etc. The tightening force of the first fastener 950 enables the connecting arm 900 to be held in position relative to the rotating assembly 200, thereby keeping the electronic terminal 90 in a specific position for convenient shooting or use.

For example, the first fastener 950 creates friction between the second connection portion 922 and the second installation protrusion 212, providing rotational damping such that the connecting arm 900 can be held in position relative to the rotating assembly 200.

In other examples, the second connection portion 922 has a first catching portion, and the second installation protrusion 212 has a second catching portion. The first fastener 950 can cause the first catching portion to engage with the second catching portion, thereby holding the connecting arm 900 in position relative to the rotating assembly 200. For instance, the first catching portion may be multiple grooves arranged around the second rotation axis, and the second catching portion may be a protrusion; or the first catching portion is a protrusion, and the second catching portion is multiple grooves arranged around the second rotation axis.

In other implementations, the connecting arm 900 is held in position relative to the rotating assembly 200 by other means, such as the user's hand force.

In other implementations, the second connection portion 922 is rotatably arranged on the second installation protrusion 212, and the second connection portion 922 and the second installation protrusion 212 are in an interference fit to hold the connecting arm 900 in position relative to the rotating assembly 200.

In other implementations, the second connection portion 922 has a first catching portion, and the second installation protrusion 212 has a second catching portion. The first catching portion engages with the second catching portion to hold the connecting arm 900 in position relative to the rotating assembly 200. For example, the second catching portion is multiple grooves arranged around the second rotation axis, the first catching portion is a protrusion, and the first catching portion can move axially to engage or disengage from the second catching portion; or, the first catching portion is multiple grooves arranged around the second rotation axis, the second catching portion is a protrusion, and the second catching portion can move axially to engage or disengage from the first catching portion.

In some implementations, the second connection portion 922 includes at least one first connection plate 922a spaced apart. The second installation protrusion 212 includes at least one second connection plate 212a spaced apart. The at least one first connection plate 922a and the at least one second connection plate 212a are interleaved. Both the first and second connection plates are thin sheets. The first fastener 950 causes adjacent first connection plates 922a and second connection plates 212a to be tightly pressed together. The first fastener 950 includes a nut 951 and screw 952 that are cooperatively engaged. When the second connection portion 922 rotates relative to the second installation protrusion 212, both the nut 951 and the screw 952 remain stationary relative to the second installation protrusion 212, or both remain stationary relative to the second connection portion 922 (for example, both the nut 951 and a head 952a of the screw 952 are in direct tight contact with the second installation protrusion 212, or both the nut 951 and the head 952a of the screw 952 are in direct tight contact with the second connection portion 922).

It can be understood that the arrangement of at least one first connection plate 922a and at least one second connection plate 212a enables the first fastener 950 to achieve a large frictional damping force between the second connection portion 922 and the second installation protrusion 212 with a relatively small tightening force. Having both the nut 951 and the screw 952 remain stationary relative to the second installation protrusion 212, or having both the nut 951 and the screw 952 remain stationary relative to the second connection portion 922, may prevent relative movement between the nut 951 and the screw 952, which could cause the first fastener 950 to loosen during the use of the terminal stand. For example, both the nut 951 and the head 952a of the screw 952 are in direct tight contact with the second installation protrusion 212 or the second connection portion 922, which may avoid relative movement between the nut 951 and the screw 952, thereby preventing the first fastener 950 from loosening during the use of the terminal stand.

For example, the first fastener 950 is in direct tightening contact with one of the first connection plates 922a, or the first fastener 950 is in direct tightening contact with one of the second connection plates 212a.

It can be understood that both the first connection plate 922a and the second connection plate 212a are thin sheets. When compressed by the first fastener 950, the first connection plate 922a and the second connection plate 212a deform easily, ensuring tight contact between adjacent first connection plate 922a and second connection plate 212a.

It can be understood that between two adjacent first connection plates 922a there is one second connection plate 212a, and between two adjacent second connection plates 212a there is one first connection plate 922a.

For example, the number of first connection plates 922a is at least two, and the number of second connection plates 212a is at least two.

In some implementations, the first connection portion 921 is located between the first installation protrusion 211 and the second installation protrusion 212. The first connection portion 921 defines an accommodation groove 903. The nut 951 is accommodated in the accommodation groove 903.

The nut 951 is peripherally fixed relative to the second installation protrusion 212 or the second connection portion 922 about the second rotation axis. The head 952a of the screw 952 includes an adjustment portion 952b. Adjusting the head 952a of the screw 952 can tighten the first fastener 950.

The connecting arm 900 defines a second opening 904. The second opening 904 is in direct communication with the accommodation cavity 901, the second wire passage channel 902, and the accommodation groove 903. The power source 800 may be mounted into the accommodation cavity 901 through the second opening 904. The nut 951 may be mounted into the accommodation groove 903 through the second opening 904.

The connecting assembly further includes a cover 960. The cover 960 matches the second opening 904 and is detachably arranged on the connecting arm 900. The cover 960 seals the second opening 904.

It can be understood that placing the first connection portion 921 between the first installation protrusion 211 and the second installation protrusion 212 makes the structure of the terminal stand more compact.

It can be understood that accommodating the nut 951 in the accommodation groove 903 makes the structure of the terminal stand more compact.

It can be understood that peripherally fixing the nut 951 relative to the installation protrusion or the second connection portion 922 prevents the nut 951 from rotating when adjusting the head 952a of the screw 952, making the first fastener 950 easier to adjust.

It can be understood that the power source 800, the nut 951, and the connecting wire 50 may all be mounted into the interior of the connecting arm 900 through the second opening 904, making the structure of the connecting arm 900 more compact.

It can be understood that the connecting wire 50 may be mounted into the second wire passage channel 902 through the second opening 904, or the second opening 904 facilitates moving the connecting wire 50 to ease its installation into the second wire passage channel 902.

For example, the adjustment portion 952b is a recess, such as a cross recess, a slot recess, a Torx recess, a polygonal recess, etc.; or the adjustment portion 952b is a protrusion, such as a slot protrusion, a cross protrusion, a Torx protrusion, a polygonal protrusion, etc.

For example, the cover 960 is snap-connected to the connecting arm 900, or the cover 960 is fastened to the connecting arm 900 by a second fastener 961. The second fastener 961 passes through the cover 960 and then is fastened to the connecting arm 900 (or, the second fastener 961 passes through the connecting arm 900 and then is fastened to the cover 960). For example, the second fastener 961 may be a rivet or a threaded fastener.

In some implementations, the first connection portion 921 is located between the first installation protrusion 211 and the second installation protrusion 212. The first connection portion 921 defines an accommodation groove 903. The second installation protrusion 212 includes a third protrusion 214 on a side close to the first connection portion 921. The third protrusion 214 is accommodated in the accommodation groove 903. The third protrusion 214 defines an installation groove 203. The nut 951 is arranged in the installation groove 203. The nut 951 is accommodated in the accommodation groove 903. The nut 951 is peripherally fixed relative to the installation groove 203 about the second rotation axis. The head 952a of the screw 952 includes an adjustment portion 952b. Adjusting the head 952a of the screw 952 can tighten the first fastener 950. The connecting arm 900 defines a second opening 904. The second opening 904 is in communication with the accommodation cavity 901. The power source 800 may be mounted into the accommodation cavity 901 through the second opening 904. The second opening 904 is in communication with the accommodation groove 903. During the process of mounting the connection protrusion 920 onto the rotating assembly 200, the third protrusion 214 may be mounted into the accommodation groove 903 through the second opening 904. The nut 951 may be mounted into the installation groove 203 through the second opening 904. The second opening 904 is in communication with the second wire passage channel 902. The connecting assembly further includes a cover 960. The cover 960 matches the second opening 904 and is detachably arranged on the connecting arm 900. The cover 960 seals the second opening 904. One of the at least one second connection plate 212a is a second connection sub-plate 212a′. The second connection sub-plate 212a′ is connected to or close to the first connection portion 921. The third protrusion 214 is arranged on the second connection sub-plate 212a′. It can be understood that the second connection sub-plate 212a′ is a second connection plate 212a closest to the first connection portion 921 among the at least one second connection plate 212a.

It can be understood that during the process of mounting the connection protrusion 920 onto the rotating assembly 200, the third protrusion 214 may be mounted into the accommodation groove 903 through the second opening 904, thereby facilitating the installation of the connection protrusion 920 onto the rotating assembly 200.

It can be understood that the nut 951 is in direct tight contact with the second connection sub-plate 212a′, which facilitates tight contact between the second connection plates 212a and the first connection plates 922a. Simultaneously, the head 952a of the screw 952 is in direct tight contact with the second installation protrusion 212, ensuring that when the second connection portion 922 rotates relative to the second installation protrusion 212, both the nut 951 and the screw 952 remain stationary relative to the second installation protrusion 212.

For example, the second installation protrusion 212 includes a second installation sub-protrusion 212c, a second connection plate 212a, and a second decorative cover 212d. The second connection plate 212a is located between the first installation protrusion 211 and the second installation sub-protrusion 212c. The connection protrusion 920 is located between the first installation protrusion 211 and the second installation sub-protrusion 212c. The head 952a of the screw 952 is in direct tight contact with the second installation sub-protrusion 212c. The second installation sub-protrusion 212c defines a fourth opening 204b. The second decorative cover 212d is detachably arranged on the fourth opening 204b. The second decorative cover 212d is configured to seal the fourth opening 204b. The head 952a of the screw 952 is in direct tight contact with the second decorative cover 212d.

For example, the first installation protrusion 211 defines a third opening 204a. The second rotation axis passes through the third opening 204a. The third opening 204a is in communication with the first wire passage channel 202. The nut 951 may be mounted into the accommodation groove 903 through the third opening 204a, the first wire port 202a, and the second wire port 902a. The nut 951 may be mounted into the installation groove 203 through the third opening 204a, the first wire port 202a, and the second wire port 902a.

For example, a first decorative cover 211a is detachably arranged on the third opening 204a to seal the third opening 204a.

In some implementations, the driving assembly 300 is arranged on the rotating assembly 200. The driving assembly 300 includes a driving main body 310 and an output shaft 320. The output shaft 320 is rotatably arranged on the driving main body 310. The driving main body 310 is fixed to the rotating assembly 200. The output shaft 320 is transmission-connected to the fixing assembly 100. The rotation of the output shaft 320 relative to the driving main body 310 causes the rotating assembly 200 to rotate relative to the fixing assembly 100 about the first rotation axis. The driving assembly 300 further includes a first gear 330 fixed to the output shaft 320. The gimbal assembly 20 includes a second gear 410. The second gear 410 is coaxial with the first rotation axis. The second gear 410 is fixed relative to the fixing assembly 100. The second gear 410 meshes with the first gear 330.

It can be understood that the advantage of providing the first gear 330 and the second gear 410 is that it facilitates setting a reasonable transmission ratio, thereby controlling the rotation speed of the rotating assembly 200 relative to the fixing assembly 100.

It can be understood that when the driving assembly 300 is activated, the output shaft 320 and the first gear 330 rotate about the driving main body 310 on one hand, and on the other hand, the output shaft 320, the first gear 330, the driving main body 310, and the rotating assembly 200 rotate as a whole relative to the fixing assembly 100 about the first rotation axis. The first gear 330 may be a planetary gear.

For example, the rotation axis of the first gear 330 is parallel to the rotation axis of the second gear 410.

For example, the rotation axis of the first gear 330 is not parallel to the rotation axis of the second gear 410.

For example, the first gear 330 is a cylindrical gear or a bevel gear, and the second gear 410 is a cylindrical gear or a bevel gear.

For example, the second gear 410 is located within the installation space 201.

For example, the first gear 330 has a third rotation axis. An outer sidewall of the bearing 600 surrounds the third rotation axis. The second gear 410 is coaxial with the bearing 600. The advantage of this arrangement is that it makes the structure of the gimbal assembly 20 compact.

In some implementations, the gimbal assembly 20 further includes a circuit board assembly 500 arranged on the rotating assembly 200. The circuit board assembly 500 is located within the installation space 201. The circuit board assembly 500 includes a first circuit board 510 and a second circuit board 520 electrically connected to the first circuit board 510. The second circuit board 520 or the first circuit board 510 is electrically connected to the driving assembly 300. The driving main body 310 has a first end face 301. The output shaft 320 extends from the first end face 301. The circuit board assembly 500 and the output shaft 320 are located on opposite sides of the first end face 301, respectively.

For example, the circuit board assembly 500 is located on a side of the driving main body 310 away from the output shaft 320.

The rotating assembly 200 includes a first outer shell 210. The first outer shell 210 encloses to define the installation space 201. The first circuit board 510 and the second circuit board 520 are arranged spaced apart. The first rotation axis is located between the first circuit board 510 and the second circuit board 520.

It can be understood that dividing the circuit board assembly 500 into spaced-apart first and second circuit boards 510, 520 may reduce the space occupied by the circuit board assembly 500. Furthermore, having the first rotation axis located between the first and second circuit boards 510, 520 may reduce eccentric vibration of the circuit board assembly 500, thereby making the rotation of the rotating assembly 200 more stable.

It can be understood that the circuit board assembly 500 and the output shaft 320 are located on opposite sides of the first end face 301 (for example, the circuit board assembly 500 is placed on an end of the driving assembly 300 away from the output shaft 320). This may prevent the circuit board assembly 500 from occupying the space on a side of the driving assembly 300 near the output shaft 320, facilitating the arrangement of components like the output shaft 320, the first gear 330, and the second gear 410 within the installation space 201, and facilitating the driving connection between the driving assembly 300 and the fixing assembly 100, thereby making the structure of the gimbal assembly 20 more compact.

For example, the circuit board assembly 500 is configured to carry corresponding chips or connect to peripheral interfaces. The peripheral interfaces may be charging interfaces, USB interfaces, cameras, etc. The chips may be chips for controlling the driving assembly 300.

For example, the first installation protrusion 211 and the second installation protrusion 212 protrude from the first outer shell 210.

For example, both the first circuit board 510 and the second circuit board 520 are fixedly arranged on a first inner shell 220.

For example, the first circuit board 510 is arranged on the first inner shell 220 by a seventh fastener 530. The seventh fastener 530 passes through the first circuit board 510 and is fastened to the first inner shell 220, or the seventh fastener 530 passes through the first inner shell 220 and is fastened to the first circuit board 510. The seventh fastener 530 may be a threaded fastener or a rivet. The first inner shell 220 is arranged with a fifth connection post 221 adapted to the seventh fastener 530. When the seventh fastener 530 is a threaded fastener, it threadedly engages with the fifth connection post 221.

For example, the second circuit board 520 is arranged on the first inner shell 220 by an eighth fastener 540. The eighth fastener 540 passes through the second circuit board 520 and is fastened to the first inner shell 220, or the eighth fastener 540 passes through the first inner shell 220 and is fastened to the second circuit board 520. The eighth fastener 540 may be a threaded fastener or a rivet. The first inner shell 220 is arranged with a sixth connection post 222 adapted to the eighth fastener 540. When the eighth fastener 540 is a threaded fastener, it threadedly engages with the sixth connection post 222.

It should be understood that when a fastener passes through A and is fastened to B, the fastener may be a threaded fastener or a rivet. When the fastener is a threaded fastener, a threaded portion of the fastener passes through A and threadedly engages with B, and a head of the fastener presses against A. When the fastener is a rivet, a riveting end of the fastener passes through A and is riveted to B, and a head of the fastener presses against A.

In some implementations, the gimbal assembly 20 further includes a bearing 600. The bearing 600 is located within the installation space 201. The bearing 600 includes an inner ring 610, an outer ring 620, and rolling elements (e.g., balls) 630. The inner ring 610 is sleeved on an inner side of the outer ring 620. The rolling elements 630 are rollably arranged between the inner ring 610 and the outer ring 620. The inner ring 610 is peripherally fixed relative to the fixing assembly 100 about the first rotation axis. The outer ring 620 is peripherally fixed relative to the rotating assembly 200 about the first rotation axis. The inner ring 610 cannot be detached from the fixing assembly 100. The outer ring 620 cannot be detached from the rotating assembly 200.

Alternatively, the inner ring 610 is peripherally fixed relative to the rotating assembly 200 about the first rotation axis. The outer ring 620 is peripherally fixed relative to the fixing assembly 100 about the first rotation axis. The inner ring 610 cannot be detached from the rotating assembly 200. The outer ring 620 cannot be detached from the fixing assembly 100.

For example, the inner ring 610 is fixedly arranged on the fixing assembly 100, and the outer ring 620 is fixedly arranged on the rotating assembly 200.

For example, the inner ring 610 is fixedly arranged on the rotating assembly 200, and the outer ring 620 is fixedly arranged on the fixing assembly 100.

It can be understood that the bearing 600 may greatly reduce the rotational resistance between the rotating assembly 200 and the fixing assembly 100, thereby enabling the rated torque of the driving assembly 300 to be smaller, making the volume of the gimbal assembly 20 more compact.

It can be understood that the bearing 600 is coaxial with the first rotation axis.

It can be understood that the bearing 600 is configured to enable the rotating assembly 200 to rotate about the fixing assembly 100.

It can be understood that locating the bearing 600 within the installation space 201 makes the structure of the gimbal assembly 20 more compact.

It can be understood that the usage scenarios of the terminal stand are varied. The bearing 600 can withstand not only radial loads but also axial loads. For example, to maintain the rotation of the rotating assembly 200 relative to the fixing assembly 100 about the first rotation axis, the bearing 600 is required to withstand radial loads. When the first rotation axis is vertical, to support the electronic terminal 90, the bearing 600 is required to withstand axial loads.

In some implementations, the outer ring 620 is sleeved on an inner side of the rotating assembly 200. The outer ring 620 is peripherally fixed relative to the rotating assembly 200 about the first rotation axis. The gimbal assembly 20 includes a first limiting portion 231 and a second limiting portion 241. A top end face of the outer ring 620 is configured to bear against the first limiting portion 231 to enable the outer ring 620 to support the rotating assembly 200. The outer ring 620 is located between the first limiting portion 231 and the second limiting portion 241 to prevent the outer ring 620 from being detached from the rotating assembly 200. The fixing assembly 100 is sleeved on an inner side of the inner ring 610. The inner ring 610 is peripherally fixed relative to the fixing assembly 100 about the first rotation axis. The gimbal assembly 20 includes a third limiting portion 113 and a fourth limiting portion 421. The third limiting portion 113 is configured to bear against a bottom end face of the inner ring 610 to enable the fixing assembly 100 to support the inner ring 610. The inner ring 610 is located between the third limiting portion 113 and the fourth limiting portion 421 to prevent the inner ring 610 from detaching from the rotating assembly 200.

Alternatively, the rotating assembly 200 is sleeved on an inner side of the inner ring 610. The inner ring 610 is peripherally fixed relative to the rotating assembly 200 about the first rotation axis. The gimbal assembly 20 includes a first limiting portion 231 and a second limiting portion 241. A top end face of the inner ring 610 is configured to bear against the first limiting portion 231 to enable the inner ring 610 to support the rotating assembly 200. The inner ring 610 is located between the first limiting portion 231 and the second limiting portion 241 to prevent the inner ring 610 from detaching from the rotating assembly 200. The outer ring 620 is sleeved on an inner side of the fixing assembly 100. The outer ring 620 is peripherally fixed relative to the fixing assembly 100 about the first rotation axis. The gimbal assembly 20 includes a third limiting portion 113 and a fourth limiting portion 421. The third limiting portion 113 is configured to bear against a bottom end face of the outer ring 620 to enable the fixing assembly 100 to support the inner ring 610. The outer ring 620 is located between the third limiting portion 113 and the fourth limiting portion 421 to prevent the outer ring 620 from detaching from the fixing assembly 100.

It can be understood that the first and second limiting portions 231, 241 prevent the outer ring 620 from easily detaching from the rotating assembly 200. The third and fourth limiting portions 113, 421 prevent the inner ring 610 from easily detaching from the fixing assembly 100.

For example, the first limiting portion 231 and the second limiting portion 241 are part of the rotating assembly 200, or the first limiting portion 231 and the second limiting portion 241 are parts connected to the rotating assembly 200. The third limiting portion 113 and the fourth limiting portion 421 are part of the fixing assembly 100, or the third limiting portion 113 and the fourth limiting portion 421 are parts connected to the fixing assembly 100.

For example, the peripheral fixation of the outer ring 620 relative to the rotating assembly 200 about the first rotation axis may be achieved by an interference fit between the outer ring 620 and the rotating assembly 200, or by tight contact between the first limiting portion 231 and the outer ring 620, or by tight contact between the second limiting portion 241 and the outer ring 620. Specifically, the outer ring 620 has an interference fit with the rotating assembly 200, the first limiting portion 231 is in tight contact with the outer ring 620, and the second limiting portion 241 is in tight contact with the outer ring 620. For example, the peripheral fixation of the inner ring 610 relative to the fixing assembly 100 about the first rotation axis may be achieved by an interference fit between the inner ring 610 and the fixing assembly 100, or by tight contact between the third limiting portion 113 and the inner ring 610, or by tight contact between the fourth limiting portion 421 and the inner ring 610.

For example, the peripheral fixation of the inner ring 610 relative to the rotating assembly 200 about the first rotation axis may be achieved by an interference fit between the inner ring 610 and the rotating assembly 200, or by tight contact between the first limiting portion 231 and the inner ring 610, or by tight contact between the second limiting portion 241 and the inner ring 610. Specifically, the inner ring 610 has an interference fit with the rotating assembly 200, the first limiting portion 231 is in tight contact with the inner ring 610, and the second limiting portion 241 is in tight contact with the inner ring 610. The peripheral fixation of the outer ring 620 relative to the fixing assembly 100 about the first rotation axis may be achieved by an interference fit between the outer ring 620 and the fixing assembly 100, or by tight contact between the third limiting portion 113 and the outer ring 620, or by tight contact between the fourth limiting portion 421 and the outer ring 620.

For example, the outer ring 620 is located between the first limiting portion 231 and the second limiting portion 241 to prevent it from detaching from the rotating assembly 200. The inner ring 610 is located between the third limiting portion 113 and the fourth limiting portion 421 to prevent it from detaching from the rotating assembly 200. When the gimbal assembly 20 supports the electronic terminal 90, the first limiting portion 231 may prevent the outer ring 620 from detaching from the rotating assembly 200, and the third limiting portion 113 may prevent the inner ring 610 from detaching from the fixing assembly 100. When the user lifts the rotating assembly 200 or the connecting arm 900, the second limiting portion 241 may prevent the outer ring 620 from detaching from the rotating assembly 200, and the fourth limiting portion 421 may prevent the inner ring 610 from detaching from the fixing assembly 100. For example, the second limiting portion 241 is near or in contact with the bottom end face of the outer ring 620, and the fourth limiting portion 421 is near or in contact with the top end face of the inner ring 610.

For example, the inner ring 610 is located between the first limiting portion 231 and the second limiting portion 241, and the outer ring 620 is located between the third limiting portion 113 and the fourth limiting portion 421. When the gimbal assembly 20 supports the electronic terminal 90, the first limiting portion 231 may prevent the inner ring 610 from detaching from the rotating assembly 200, and the third limiting portion 113 may prevent the outer ring 620 from detaching from the fixing assembly 100. When the user lifts the rotating assembly 200 or the connecting arm 900, the second limiting portion 241 may prevent the inner ring 610 from detaching from the rotating assembly 200, and the fourth limiting portion 421 may prevent the outer ring 620 from detaching from the fixing assembly 100. For example, the second limiting portion 241 is in contact with or near the bottom end face of the inner ring 610, and the fourth limiting portion 421 is in contact with or near the top end face of the outer ring 620.

For example, the first limiting portion 231 is arranged on the rotating assembly 200, the second limiting portion 241 is detachable relative to the rotating assembly 200, the third limiting portion 113 is arranged on the fixing assembly 100, and the fourth limiting portion 421 is detachable relative to the rotating assembly 200. The advantage of this arrangement is that it facilitates the installation of the bearing 600 with the fixing assembly 100 and the installation of the bearing 600 with the rotating assembly 200.

In other implementations, the outer ring 620 is sleeved on an inner side of the rotating assembly 200. The outer ring 620 and the rotating assembly 200 have an interference fit. The rotating assembly 200 includes a first limiting portion 231. A top end face of the outer ring 620 bears against the first limiting portion 231. The fixing assembly 100 is sleeved on an inner side of the inner ring 610. The fixing assembly 100 and the inner ring 610 have an interference fit. The fixing assembly 100 includes a third limiting portion 113. The third limiting portion 113 bears against a bottom end face of the inner ring 610. Alternatively, the rotating assembly 200 is sleeved on an inner side of the inner ring 610. The inner ring 610 and the rotating assembly 200 have an interference fit. The rotating assembly 200 includes a first limiting portion 231. A top end face of the inner ring 610 bears against the first limiting portion 231. The outer ring 620 is sleeved on an inner side of the outer ring 620. The fixing assembly 100 and the outer ring 620 have an interference fit. The fixing assembly 100 includes a third limiting portion 113. The third limiting portion 113 bears against a bottom end face of the outer ring 620.

It can be understood that the interference fit between the outer ring 620 and the rotating assembly 200 is sufficient to fix the outer ring 620 to the rotating assembly 200. The interference fit between the fixing assembly 100 and the inner ring 610 is sufficient to fix the inner ring 610 to the fixing assembly 100. The advantage of providing the first limiting portion 231 and the third limiting portion 113 is that when the gimbal assembly 20 supports a heavy electronic terminal 90, it prevents slight axial displacement between the rotating assembly 200 and the outer ring 620, and prevents slight axial displacement between the inner ring 610 and the fixing assembly 100, thereby avoiding detachment of the rotating assembly 200 from the outer ring 620 and the inner ring 610 from the fixing assembly 100 during long-term or frequent use of the terminal stand.

It can be understood that the interference fit between the inner ring 610 and the rotating assembly 200 is sufficient to fix the inner ring 610 to the rotating assembly 200. The interference fit between the fixing assembly 100 and the outer ring 620 is sufficient to fix the outer ring 620 to the fixing assembly 100. The advantage of providing the first limiting portion 231 and the third limiting portion 113 is that when the gimbal assembly 20 supports a heavy electronic terminal 90, it prevents slight axial displacement between the rotating assembly 200 and the inner ring 610, and prevents slight axial displacement between the outer ring 620 and the fixing assembly 100, thereby avoiding detachment of the rotating assembly 200 from the inner ring 610 and the outer ring 620 from the fixing assembly 100 during long-term or frequent use of the terminal stand.

For example, the rotating assembly 200 includes a second inner shell 230 fixed to the first outer shell 210. The outer ring 620 is fixedly arranged on the second inner shell 230. The second inner shell 230 includes an outer sleeve 232 and a first limiting portion 231. A side of the outer ring 620 is sleeved on an inner side of the outer sleeve 232. The outer ring 620 and the outer sleeve 232 have an interference fit to achieve peripheral fixation between the outer ring 620 and the second inner shell 230 (or, the outer ring 620 and the outer sleeve 232 have a loose fit, and peripheral fixation is achieved by tight contact between the first limiting portion 231 and the second inner shell 230, or by tight contact between the second limiting portion 241 and the second inner shell 230). The first limiting portion 231 is arranged on an end of the outer sleeve 232 and extends inward. The top end face of the outer ring 620 bears against the first limiting portion 231.

The fixing assembly 100 includes a second outer shell 110. The first outer shell 210 defines a first opening 205 communicating with the installation space 201. The second outer shell 110 covers the first opening 205. The second gear 410 is peripherally fixed relative to the second outer shell 110 about the first rotation axis. The second outer shell 110 includes an end shell 111, a first inner sleeve 112, and a third limiting portion 113. The end shell 111 covers the first opening 205. The first inner sleeve 112 is arranged on the end shell 111 and extends into the installation space 201. The inner ring 610 has an interference fit with the first inner sleeve 112 (or the inner ring 610 has a loose fit with the first inner sleeve 112). The third limiting portion 113 is arranged on the inner ring 610 or the end shell 111. The third limiting portion 113 is configured to bear against the bottom end face of the inner ring 610. The second gear 410 is peripherally fixed relative to the first inner sleeve 112 about the first rotation axis.

In some implementations, the connecting arm 900 includes a connection main body 910. The power source 800 is located within the connection main body 910. Both the connection main body 910 and the power source 800 are columnar bodies. The cross-sectional area of the power source 800 is not less than 50% of the cross-sectional area of the connection main body 910.

It can be understood that the cross-sectional area of the power source 800 being not less than 50% of the cross-sectional area of the connection main body 910 enables the volume of the power source 800 to be expanded in the lateral direction, enabling a larger capacity for the power source 800, thereby improving the battery life of the gimbal assembly 20.

It can be understood that the cross-section of the power source 800 is perpendicular to its extension direction, and the cross-section of the connection main body 910 is perpendicular to its extension direction.

For example, the power source 800 and the connection main body 910 extend in the same direction.

In other examples, the extension direction of the power source 800 is different from that of the connection main body 910; for example, the power source 800 and the connection main body 910 form a small angle.

In some implementations, the extension direction of the power source 800 is the same as that of the connection main body 910, and the length of the power source 800 is not less than 50% of the length of the connection main body 910.

It can be understood that the length of the power source 800 being not less than 50% of the length of the connection main body 910 enables the volume of the power source 800 to be expanded in the longitudinal direction, enabling a larger capacity for the power source 800, thereby improving the battery life of the gimbal assembly 20.

In some implementations, the rotating assembly 200 includes a first outer shell 210. The first outer shell 210 encloses to define the installation space 201. The connecting arm 900 is arranged on the first outer shell 210.

It can be understood that the first outer shell 210 protects the driving assembly 300, the bearing 600, etc., within the installation space 201, thereby preventing external objects from affecting the rotational connection between the fixing assembly 100 and the rotating assembly 200.

It can be understood that the first outer shell 210 facilitates the installation of the connecting arm 900; for example, the connecting arm 900 is rotatably arranged on the first outer shell 210.

For example, the connecting arm 900 is fixedly arranged on the first outer shell 210, or the connecting arm 900 is rotatably arranged on the first outer shell 210.

In some implementations, the connecting arm 900 is rotatably arranged on the rotating assembly 200. The connecting arm 900 can be folded against the gimbal assembly 20. The connecting arm 900 can be held in position relative to the rotating assembly 200.

It can be understood that when the terminal stand is required to be stored, the connecting arm 900 can be folded against the gimbal assembly 20, making the occupied volume of the terminal stand smaller in the stored state.

For example, when the connecting arm 900 is folded against the gimbal assembly 20, the extension direction of the connection main body 910 is parallel to the first rotation axis.

For example, the user's hand force can achieve holding the connecting arm 900 in position relative to the rotating assembly 200.

For example, the connecting arm 900 and the rotating assembly 200 have a direct or indirect interference fit, such that the connecting arm 900 can be held in position relative to the rotating assembly 200.

For example, the connecting arm 900 can be locked to the rotating assembly 200; for instance, the connecting arm 900 is fastened to the rotating assembly 200 by a first fastener 950, or the connecting arm 900 is engaged with the rotating assembly 200 by a latching structure. The first fastener 950 may be a threaded fastener or a rivet.

For example, the connecting arm 900 is rotatably arranged on the rotating assembly 200 with damping; for instance, a damping ring is arranged between the connecting arm 900 and the rotating assembly 200. The damping ring may be made of flexible material. Alternatively, the connecting arm 900 and the rotating assembly 200 are in direct or indirect frictional contact, such that there is frictional damping between the connecting arm 900 and the rotating assembly 200. The first fastener 950 may be configured to create frictional damping between the connecting arm 900 and the rotating assembly 200. The first fastener 950 may be a threaded fastener, rivet, etc.

In some implementations, the connecting arm 900 is rotatably arranged on the rotating assembly 200 about the second rotation axis. The angle between the second rotation axis and the first rotation axis is greater than or equal to 75° and less than or equal to 90°.

It can be understood that the angle between two lines ranges from 0° to 90°.

It can be understood that the angle between the second rotation axis and the first rotation axis being greater than or equal to 75° and less than or equal to 90° enables the connecting arm 900 to have two rotational degrees of freedom relative to the support part on one hand, and on the other hand, enables the connecting arm 900 to extend into the lateral space of the gimbal assembly 20 for convenient use of the electronic terminal 90.

For example, the angle between the second rotation axis and the first rotation axis is 75°, 80°, 85°, or 90°.

In some implementations, the terminal stand further includes an accessory 260. The accessory 260 is arranged on the rotating assembly 200 and is in an exposed state relative to the rotating assembly 200. When the connecting arm 900 is folded against the rotating assembly 200, the connecting arm 900 obscures the accessory 260.

It can be understood that the connecting arm 900 obscuring the accessory 260 may, to some extent, prevent damage to the accessory 260 by external objects in certain situations, thus protecting the accessory 260, or prevent external objects from touching the accessory 260 and activating the gimbal assembly 20 in some situations.

It can be understood that the accessory 260 being exposed relative to the rotating assembly 200 means that part or all of the accessory 260 is exposed relative to the rotating assembly 200.

For example, the accessory 260 protrudes from an outer wall of the rotating assembly 200, making it exposed relative to the rotating assembly 200.

For example, the rotating assembly 200 has a first groove communicated to the outer wall of the rotating assembly 200. The accessory 260 is located in the first groove of the rotating assembly 200, making it exposed relative to the rotating assembly 200.

For example, when the connecting arm 900 obscures the accessory 260, the connecting arm 900 is attached to the outer wall of the rotating assembly 200.

For example, when the connecting arm 900 obscures the accessory 260, the connecting arm 900 is close to the outer wall of the rotating assembly 200, and there is a gap between the connecting arm 900 and the outer wall of the rotating assembly 200.

For example, the accessory 260 is a toggle protrusion, a lens, a USB interface, a charging interface, etc.

For example, the accessory 260 includes an exposed wall 260a relative to the rotating assembly 200. There is a point A defined on the exposed wall 260a. Point A is all or some of the points on the exposed wall 260a. A line perpendicular to the first rotation axis and passing through point A is defined as a first line. A first projection plane is defined perpendicular to the first line. When the connecting arm 900 obscures the accessory 260, the orthogonal projection of the point A on the first projection plane is point A1. The orthogonal projection of the connecting arm 900 on the first projection plane is an arm projection. The point A1 is located within the arm projection.

In some implementations, the support member 10 includes a first support sub-portion 12 and a support rod 11. The first support sub-portion 12 is arranged on the support rod 11. The first support sub-portion 12 can be held by a user. An outer side wall of the first support sub-portion 12 is cylindrical or approximately cylindrical. The outer side walls of the gimbal assembly 20 are all cylindrical or approximately cylindrical. One end of the gimbal assembly 20 is connected to or close to one end of the first support sub-portion 12. The first support sub-portion 12 and the gimbal assembly 20 form a first support structure. During the rotation of the rotating assembly related to the fixing assembly about the first rotation axis, the first support structure is overall a strip-like object, and can be placed horizontally on the supported plane. When the first support structure is placed horizontally on the supported plane, the angle between the first rotation axis and the supported plane is less than or equal to 3°.

An approximately cylindrical surface may be defined as follows: The approximately cylindrical surface can be placed horizontally on the supported plane. When the approximately cylindrical surface rolls arbitrarily on the supported plane, the angle between the first rotation axis and the supported plane is less than or equal to 3°.

For example, the approximately cylindrical surface may be a cylindrical-like structure with a certain draft angle, such as a cylindrical-like structure with a draft angle less than or equal to 3°, for example, a frustum of a pyramid with a draft angle less than or equal to 3°, a frustum of a cone with a draft angle less than or equal to 3°, etc.

For example, the approximately cylindrical surface has a longitudinal cross-section. The first rotation axis lies in the longitudinal cross-section. The longitudinal cross-section intersects the approximately cylindrical surface to define a first side line. The first side line is straight. The approximately cylindrical surface is formed by the envelope of infinitely many first side lines. The angle between any first side line and the first rotation axis is less than or equal to 3°.

It can be understood that the outer side wall of the first support sub-portion 12 is cylindrical or approximately cylindrical, and the outer side walls of the gimbal assembly 20 are all cylindrical or approximately cylindrical. The first support structure is overall a strip-like object, such that after the gimbal assembly 20 operates, the form of the first support structure does not change significantly, thereby facilitating the storage of the first support structure.

It can be understood that the gimbal assembly 20 being connected to or close to one end of the first support sub-portion 12 makes the volume occupied by the terminal stand when stored smaller.

It can be understood that the angle between the first rotation axis and the supported plane being less than or equal to 3° facilitates the storage of the terminal stand.

For example, the first support sub-portion 12 is a fixed structure.

For example, the first support sub-portion 12 is a movable structure. In a certain state, its outer side wall can form a cylindrical or approximately cylindrical surface.

For example, the cylindrical surface may be a circular cylindrical surface, an elliptical cylindrical surface, or a polygonal cylindrical surface.

For example, the approximately cylindrical surface may be a lateral surface of a conical frustum with a draft angle, a lateral surface of an elliptical conical frustum with a draft angle, or a lateral surface of a pyramidal frustum with a draft angle.

For example, the first support structure may be strip-shaped, block-shaped, etc.

For example, when the first support structure is placed horizontally on the supported plane, the angle between the first rotation axis and the supported plane may be 1°, 2°, 3°, etc.

For example, when the first support structure rolls arbitrarily on the supported plane, the angle between the first rotation axis and the supported plane is less than or equal to 3°.

For example, when the first support structure rolls to a specific position on the supported plane, the angle between the first rotation axis and the supported plane is less than or equal to 3°.

In some implementations, the support rod 11 is a length-adjustable rod. Extending the length-adjustable rod 11 can move the gimbal assembly 20 away from the first support sub-portion 12. Retracting the length-adjustable rod 11 can bring the gimbal assembly 20 into contact with or close to the first support sub-portion 12.

It can be understood that adjusting the length of the length-adjustable rod 11 can adjust the distance between the electronic terminal 90 and the user (or the subject being photographed), thereby facilitating the use of the electronic terminal 90.

In other examples, the support rod 11 is a fixed-length rod.

In some implementations, the first support structure includes a first support main body and the rotating assembly 200 connected to or close to the first support main body. The first support main body includes the first support sub-portion 12 and the fixing assembly 100. An outer side wall of the first support main body is a revolving port coaxial with the first rotation axis. An outer side wall of the rotating assembly 200 is a revolving port coaxial with the first rotation axis. The outer side wall of the first support structure is overall a revolving port coaxial with the first rotation axis.

It can be understood that configuring the outer side wall of the rotating assembly 200 as a revolving port prevents interference and collision between the rotating assembly 200 and external objects during operation.

It can be understood that the outer side walls of the rotating assembly 200 and the first support main body are both revolving ports, and the outer side wall of the first support structure is overall a revolving port coaxial with the first rotation axis. After the gimbal assembly 20 operates, the form of the first support structure does not change, facilitating the storage of the first support structure.

For example, the revolving port may be a circular cylindrical surface, a conical surface with a draft angle, or a combination of a circular cylindrical surface and a conical surface with a draft angle.

For example, the outer side wall of the first support sub-portion 12 and the outer side wall of the gimbal assembly 20 are both revolving ports coaxial with the first rotation axis.

In some implementations, the first support structure can be placed horizontally on the supported plane. When the first support structure is placed horizontally on the supported plane, the angle between the first rotation axis and the supported plane is less than or equal to 1°.

It can be understood that when the first support structure is placed horizontally on the supported plane, the angle between the first rotation axis and the supported plane is less than or equal to 1°, which facilitates the storage of the terminal stand.

It can be understood that a strip-like object placed horizontally means a side of the strip-like object is in contact with the supported plane, and the supported plane supports the side of the strip-like object. A columnar object placed horizontally means a side of the columnar object is in contact with the supported plane, and the supported plane supports the side of the columnar object.

For example, when the first support structure rolls arbitrarily on the supported plane, the angle between the first rotation axis and the supported plane is less than or equal to 1°.

For example, when the first support structure rolls to a specific position on the supported plane, the angle between the first rotation axis and the supported plane is less than or equal to 1°.

For example, when the first support structure is placed horizontally on the supported plane, the angle between the first rotation axis and the supported plane is 0.5°, 1°, etc.

In some implementations, the support member 10 includes a first support sub-portion 12 and a support rod 11. The first support sub-portion 12 includes at least three feet 12a, at least three links 12b, and a sliding sleeve 12c. The at least three links 12b correspond to the at least three feet 12a in a one-to-one correspondence. An end of each link 12b is rotatably connected to the support rod 11, and the other end of the link 12b is rotatably connected to a corresponding foot 12a. Each foot 12a is rotatably connected to the sliding sleeve 12c. The sliding sleeve 12c is sleeved on the support rod 11. When the sliding sleeve 12c slides relative to the support rod 11, the feet 12a can be splayed or folded relative to the support rod 11. After the at least three feet 12a are splayed, the first support sub-portion 12 can be supported on the supported plane. After the at least three feet 12a are folded, the first support sub-portion 12 can be held by a user. The support rod 11 may be a length-adjustable rod.

It can be understood that the advantage of the above arrangement is that the terminal stand can be either handheld or supported on a supported plane.

It can be understood that the sliding sleeve 12c, one of the feet 12a, the link 12b corresponding to that foot 12a, and the support rod 11 form a sliding link mechanism.

For example, the feet 12a can be folded against the support rod 11. When the feet 12a are folded, the links 12b are located between the support rod 11 and the corresponding feet 12a.

For example, the number of the feet 12a may be 3, 4, etc.

In other examples, the support rod 11 is a fixed-length rod.

In other examples, the first support sub-portion 12 includes at least three feet 12a. The feet 12a are rotatably connected to the support rod 11. Rotating the feet 12a relative to the support rod 11 can splay or fold the feet 12a relative to the support rod 11.

Some embodiments of the present disclosure further propose a gimbal assembly 20 for a terminal stand. The gimbal assembly 20 includes a fixing assembly 100, a rotating assembly 200, a driving assembly 300, and a locking assembly. The rotating assembly 200 is rotatable relative to the fixing assembly 100 about a first rotation axis. The driving assembly 300 is configured to drive the rotating assembly 200 to rotate relative to the fixing assembly 100. The locking assembly includes a first locking member 700 and a second locking member 420. The first locking member 700 is movably arranged on the rotating assembly 200. The second locking member 420 is fixedly arranged on the fixing assembly 100. Movement of the first locking member 700 relative to the rotating assembly 200 can cause the first locking member 700 to be locked with or disengaged from the second locking member 420. The first locking member 700 locked with the second locking member 420 fixes the rotating assembly 200 relative to the fixing assembly 100 about the first rotation axis. The first locking member 700 disengaged from the second locking member 420 enables the rotating assembly 200 to rotate relative to the fixing assembly 100 about the first rotation axis.

It can be understood that when the terminal stand is not in use, the rotating assembly 200 can be locked to the fixing assembly 100 via the first locking member 700 and the second locking member 420, keeping the gimbal assembly 20 in a stable state, thereby keeping the entire terminal stand in a stable state, which may facilitate the carrying of the terminal stand.

For example, the first locking member 700 is slidably arranged on the rotating assembly 200, or the first locking member 700 is rotatably arranged on the rotating assembly 200.

For example, the first locking member 700 and the second locking member 420 engage frictionally to achieve locking.

For example, the first locking member 700 has a locking pin, and the second locking member 420 has a locking hole. Inserting the locking pin into the locking hole achieves locking between the first locking member 700 and the second locking member 420. Alternatively, the first locking member 700 has a locking hole, and the second locking member 420 has a locking pin. Inserting the locking pin into the locking hole achieves locking between the first locking member 700 and the second locking member 420.

In some implementations, the first locking member 700 is slidably arranged on the rotating assembly 200.

For example, the sliding direction of the first locking member 700 is parallel to the first rotation axis.

For example, the sliding direction of the first locking member 700 is at an angle to the first rotation axis.

In some implementations, the first locking member 700 includes a first locking portion 710. The first locking portion 710 is a first tooth 710 extending along the sliding direction of the first locking member 700. The number of the first teeth 710 is at least one. The second locking member 420 has a second locking portion 421 that can be locked with or disengaged from the first locking portion 710. The second locking portion 421 includes multiple second teeth 421. The multiple second teeth 421 are uniformly arranged around the first rotation axis. A tooth groove 401 is defined between every two adjacent second teeth 421. The first tooth 710 is adapted to the tooth groove 401. Sliding the first locking member 700 relative to the rotating assembly 200 can cause the first tooth 710 to be inserted into or disengaged from the tooth groove 401.

It can be understood that when the first tooth 710 is inserted into the tooth groove 401, the first locking member 700 and the second locking member 420 are locked together.

It can be understood that the uniform distribution of the multiple tooth grooves 401 facilitates the insertion of the first tooth 710 into the corresponding tooth groove 401.

For example, the number of first teeth 710 is one, two, etc.

For example, the number of second teeth 421 may be 3, 4, 5, 6, 7, 9, 10, 15, 20, 30, etc.

In some implementations, an end of the first tooth 710 is arranged with a first insertion tip 711. The first insertion tip 711 gradually narrows along the insertion direction of the first tooth 710 to facilitate the insertion of the first tooth 710 into the tooth groove 401; and/or, an end of the second tooth 421 is arranged with a second insertion tip. The second insertion tip gradually narrows along a direction opposite to the insertion direction of the first tooth 710 to facilitate the insertion of the first tooth 710 into the tooth groove 401.

It can be understood that the first insertion tip 711 gradually narrowing along the insertion direction of the first tooth 710 means that when the first tooth 710 is not directly aligned with the tooth groove 401, the first insertion tip 711 is only required to correspond to (faces) the tooth groove 401 for inserting the first tooth 710 into the tooth groove 401.

It can be understood that the second insertion tip gradually narrowing along the direction opposite to the insertion direction of the first tooth 710 means the space between two adjacent second insertion tips is larger than the tooth groove 401, making it easier for the first tooth 710 to be inserted into the tooth groove 401 when not directly aligned.

For example, a part of the first insertion tip 711 away from the first tooth 710 has a sharp end or a fine part.

For example, a part of the second insertion tip near the first tooth 710 has a sharp end or a fine part.

In some implementations, the rotating assembly 200 includes a first outer shell 210. The first outer shell 210 encloses to define an installation space 201. The driving assembly 300 is located in the installation space 201. The first outer shell 210 defines a toggle groove 206. The first locking member 700 includes a toggle protrusion 720. The toggle protrusion 720 can be toggled by a user to cause the first locking member 700 to be locked with or disengaged from the second locking member 420. The toggle groove 206 serves as a movement space for the toggle protrusion 720.

It can be understood that providing the toggle protrusion 720 in the toggle groove 206 of the first outer shell 210 facilitates user operation. Locating the driving assembly 300 in the installation space 201 makes the structure of the gimbal assembly 20 more compact.

For example, the toggle protrusion 720 is adapted to the toggle groove 206. The sliding connection between the toggle protrusion 720 and the toggle groove 206 enables a slidable installation of the first locking member 700 on the rotating assembly 200.

In other examples, the toggle groove 206 only serves as a movement space for the toggle protrusion 720.

For example, the toggle protrusion 720 is located within the toggle groove 206; or, the toggle protrusion 720 extends out through the toggle groove 206.

For example, an outer surface of the toggle protrusion 720 is arranged with an anti-slip pattern to facilitate user toggling.

For example, the first locking portion 710 is located within the installation space 201. The toggle groove 206 is in communication with the installation space 201.

In other examples, the first locking portion 710 is located outside the installation space 201.

In other implementations, the first locking member 700 has a toggle lever. The toggle lever can be toggled by a user. Toggling the toggle lever can cause the first locking member 700 to be locked with or disengaged from the second locking member 420.

In some implementations, the rotating assembly 200 further includes a first inner shell 220. The first inner shell 220 is located in the installation space 201. The first inner shell 220 is fixedly arranged on the first outer shell 210. The first locking member 700 further includes a first main body 730. The first main body 730 is confined between the first inner shell 220 and the first outer shell 210. The toggle groove 206 is in communication with the installation space 201. The toggle protrusion 720 protrudes from the first main body 730. The first locking member 700 includes a first locking portion 710. The first locking portion 710 is arranged on the first main body 730. The second locking member 420 includes a second locking portion 421 that can be locked with or disengaged from the first locking portion 710. Both the first locking portion 710 and the second locking portion 421 are located in the installation space 201.

It can be understood that placing the first main body 730, the first locking portion 710, and the second locking portion 421 all within the installation space 201 makes the structure of the gimbal assembly 20 more compact on one hand, and avoids the influence of external objects on the engagement between the first locking portion 710 and the second locking portion 421 on the other hand.

It can be understood that confining the first main body 730 between the first inner shell 220 and the first outer shell 210 makes the structure of the gimbal assembly 20 more compact on one hand, and makes the sliding of the first locking member 700 relative to the rotating assembly 200 more stable on the other hand.

For example, a space between the first inner shell 220 and the first outer shell 210 is a columnar space (or part of a columnar space), and the first main body 730 is an adapted columnar body (or part of a columnar body).

For example, the first locking portion 710 is directly or indirectly arranged on the first main body 730.

For example, the toggle protrusion 720 is integrally connected to the first main body 730.

For example, the toggle protrusion 720 is detachably connected to the first main body 730. The toggle protrusion 720 is arranged with a second engagement portion 721. The first main body 730 is arranged with a third engagement portion 701. The second engagement portion 721 engages with the third engagement portion 701. The second engagement portion 721 is a protrusion and the third engagement portion 701 is a groove; or, the second engagement portion 721 is a groove and the third engagement portion 701 is a protrusion.

In other examples, the first main body 730 is located outside the installation space 201, the first locking portion 710 is located within the installation space 201, and the second locking portion 421 is located outside the installation space 201.

In some implementations, the first inner shell 220 defines a first sliding groove 207. The first main body 730 is slidably arranged in the first sliding groove 207; and/or, the toggle protrusion 720 slidably engages with the toggle groove 206.

It can be understood that the slidable installation of the first locking member 700 on the rotating assembly 200 may be achieved by slidably mounting the first main body 730 on the rotating assembly 200, or by slidably mounting the toggle protrusion 720 in the toggle groove 206.

In other implementations, the first outer shell 210 defines a first sliding groove 207.

It can be understood that the slidable installation of the first main body 730 in the first sliding groove 207 enables the first locking member 700 to slide relative to the rotating assembly 200.

It can be understood that the slidable movement of the toggle protrusion 720 relative to the toggle groove 206 enables the first locking member 700 to slide relative to the rotating assembly 200.

It can be understood that since the first main body 730 is confined between the first inner shell 220 and the first outer shell 210, the tendency of the first main body 730 to move towards the first outer shell 210 and disengage from the first sliding groove 207 can be limited solely by the first outer shell 210.

For example, the first sliding groove 207 includes two opposite third sidewalls 207a. The third sidewalls 207a extend along the sliding direction of the first locking member 700. The two opposite sides of the first main body 730 correspond to the two third sidewalls 207a.

For example, the first sliding groove 207 is a “U” shaped groove. The first sliding groove 207 and the first outer shell 210 together enclose to define a sliding space. The first main body 730 is slidable within this sliding space, thereby achieving the slidable installation of the first locking member 700 on the rotating assembly 200.

In other examples, the first sliding groove 207 may be a T-slot or a dovetail slot. The first main body 730 has a corresponding T-shaped structure or dovetail structure. The slidable installation of the first locking member on the rotating assembly 200 may be achieved solely through the cooperation between the first main body 730 and the first sliding groove 207. In this case, the first outer shell 210 may prevent the first main body 730 from being disengaged from the first sliding groove 207, thereby achieving more stable sliding of the first locking member 700 relative to the first outer shell 210.

For example, the toggle groove 206 is a “U”-shaped groove.

In other examples, the toggle groove 206 is a T-slot or a dovetail slot.

In some implementations, the rotating assembly 200 is arranged with a first limiting wall 208a for limiting the sliding of the first locking member 700. When the first locking member 700 abuts against the first limiting wall 208a, the first locking member 700 and the second locking member 420 are in a locked state. The rotating assembly 200 is arranged with a second limiting wall 208b for limiting the sliding of the first locking member 700. When the first locking member 700 abuts against the second limiting wall 208b, the first locking member 700 is disengaged from the second locking member 420.

The first limiting wall 208a is arranged on the first inner shell 220. When the first main body 730 abuts against the first limiting wall 208a, the first locking member 700 and the second locking member 420 are locked; and/or, the first limiting wall 208a is arranged on a first sidewall of the toggle groove 206. When the toggle protrusion 720 abuts against the first limiting wall 208a, the first locking member 700 and the second locking member 420 are locked.

The second limiting wall 208b is arranged on the first inner shell 220. When the first main body 730 abuts against the first limiting wall 208a, the first locking member 700 is disengaged from the second locking member 420; and/or, the second limiting wall 208b is arranged on a second sidewall of the toggle groove 206. When the toggle protrusion 720 abuts against the first limiting wall 208a, the first locking member 700 is disengaged from the second locking member 420.

It can be understood that the first limiting wall 208a enables the first locking member 700 to slide quickly and accurately to a locking position. The provision of the second limiting wall 208b enables the first locking member 700 to slide quickly and accurately to an unlocking position.

For example, a part of the first main body 730 is located between the first limiting wall 208a and the second limiting wall 208b; or, the first main body 730 is located between the first limiting wall 208a and the second limiting wall 208b.

For example, the first main body 730 includes a side protrusion 731 on a side. The side protrusion 731 is located between the first limiting wall 208a and the second limiting wall 208b. When the side protrusion 731 abuts against the first limiting wall 208a, the first locking member 700 and the second locking member 420 are locked. When the side protrusion 731 abuts against the second limiting wall 208b, the first locking member 700 is disengaged from the second locking member 420. A first extension protrusion 740 protrudes from the side protrusion 731 towards the first switch 550.

For example, the first sidewall and the second sidewall may be two opposite sidewalls of the toggle groove 206.

In some implementations, the gimbal assembly 20 further includes a first switch 550. The first switch 550 is fixed relative to the rotating assembly 200. The first switch 550 is electrically connected to the driving assembly 300. The first switch 550 has an ON state and an OFF state. When the first switch 550 is in the OFF state, the driving assembly 300 stops.

The first locking member 700 includes a first triggering portion 702 and a second triggering portion 703. When the first locking member 700 slides to lock with the second locking member 420, the first triggering portion 702 triggers the first switch 550 to set it to the OFF state. When the first locking member 700 slides to disengage from the second locking member 420, the second triggering portion 703 triggers the first switch 550 to set it to the ON state.

Alternatively, the first locking member 700 includes a first triggering portion 702. When the first locking member 700 slides to lock with the second locking member 420, the first triggering portion 702 triggers the first switch 550 to set it to the OFF state. When the first locking member 700 slides to disengage from the second locking member 420, the first switch 550 resets to the ON state.

Alternatively, the first locking member 700 includes a second triggering portion 703. When the first locking member 700 slides to lock with the second locking member 420, the first switch 550 resets to the OFF state. When the first locking member 700 slides to disengage from the second locking member 420, the second triggering portion 703 triggers the first switch 550 to set it to the ON state.

It can be understood that when the first locking member 700 and the second locking member 420 are locked, the first switch 550 is in the OFF state, causing the driving assembly 300 to stop operating, thereby preventing potential damage to the gimbal assembly 20 if the driving assembly 300 were to continue moving. Moreover, the first locking member 700 serves both a locking function and a function of triggering the first switch 550, making the structure of the gimbal assembly 20 more compact.

It can be understood that the closure (ON state) of the first switch 550 is one of the necessary conditions for starting the driving assembly 300.

It can be understood that at least one of the ON and OFF states of the first switch 550 is triggered by the first locking member 700.

For example, both the ON and OFF states of the first switch 550 are triggered by the first locking member 700. The first switch 550 includes a first protrusion 551. The first locking member 700 defines a first groove 704. The first protrusion 551 is embedded in the first groove 704. During the sliding of the first locking member 700, the first protrusion 551 is toggled or pivoted. The first groove 704 has opposite fourth and fifth sidewalls. During the sliding of the first locking member 700 to lock with the second locking member 420, the fourth sidewall contacts the first protrusion 551; the fourth sidewall is the first triggering portion 702. During the sliding of the first locking member 700 to disengage from the second locking member 420, the fifth sidewall contacts the first protrusion 551; the fifth sidewall is the second triggering portion 703.

For example, the OFF state of the first locking member 700 is triggered by the first locking member 700. The first switch 550 includes a first protrusion 551. The first locking member 700 has a fourth sidewall. During the sliding of the first locking member 700 to be locked with the second locking member 420, the fourth sidewall contacts the first protrusion 551; the fourth sidewall is the first triggering portion 702.

For example, the ON state of the first locking member 700 is triggered by the first locking member 700. The first switch 550 includes a first protrusion 551. The first locking member 700 has a fifth sidewall. During the sliding of the first locking member 700 to be disengaged from the second locking member 420, the fifth sidewall contacts the first protrusion 551; the fifth sidewall is the second triggering portion 703.

In some implementations, the rotating assembly 200 includes a first outer shell 210 and a first inner shell 220. The first outer shell 210 encloses to define the installation space 201. The driving assembly 300 and the first inner shell 220 are located in the installation space 201. The first inner shell 220 is fixedly arranged on the first outer shell 210. The first inner shell 220 is located between the first switch 550 and the first outer shell 210. The first locking member 700 includes a first main body 730 and a first extension protrusion 740. The first main body 730 is confined between the first inner shell 220 and the first outer shell 210. The first extension protrusion 740 is arranged on the first main body 730 and extends towards the first switch 550. The first triggering portion 702 is arranged on the first extension protrusion 740. The second triggering portion 703 is arranged on the first extension protrusion 740. The first inner shell 220 defines a first avoidance space 209. The first avoidance space 209 is configured to avoid the first extension protrusion 740 when the first locking member 700 slides.

The gimbal assembly 20 includes a circuit board assembly 500. The circuit board assembly 500 is fixedly arranged on the rotating assembly 200. The circuit board assembly 500 is electrically connected to the driving assembly 300.

The circuit board assembly 500 is located within the installation space 201. The first inner shell 220 is located between the circuit board assembly 500 and the first outer shell 210. The first switch 550 is arranged on the circuit board assembly 500.

It can be understood that placing the first inner shell 220 between the first switch 550 and the first outer shell 210 makes the structure of the gimbal assembly 20 more compact and occupies less volume. Moreover, the confinement of the first main body 730 by both the first inner shell 220 and the first outer shell 210 makes the sliding of the first locking member 700 more stable.

It can be understood that placing the first inner shell 220 between the circuit board assembly 500 and the first outer shell 210 makes the structure of the gimbal assembly 20 more compact. The confinement of the first main body 730 by both the first inner shell 220 and the first outer shell 210 makes the sliding of the first locking member 700 more stable.

In other examples, the first switch 550 is directly fixed to the driving assembly 300.

It can be understood that the first groove 704 is arranged on the first extension protrusion 740. The fourth and fifth sidewalls are located on the first extension protrusion 740.

In some implementations, the first main body 730 is slidably arranged on the rotating assembly 200, thereby achieving the slidable installation of the first locking member 700 on the rotating assembly 200.

In some implementations, the second locking portion 421 is closer to the first rotation axis than the first main body 730. The first locking portion 710 is closer to the first rotation axis than the first main body 730. The first locking member 700 includes a second extension protrusion 750 protruding from the first main body 730. The first locking portion 710 is arranged on the second extension protrusion 750.

It can be understood that the second locking portion 421 being closer to the first rotation axis than the first main body 730 and the first locking portion 710 being closer to the first rotation axis than the first main body 730 makes the structure of the gimbal assembly 20 more compact.

It can be understood that the second locking portion 421 being closer to the first rotation axis than the first main body 730 and the first locking portion 710 being closer to the first rotation axis than the first main body 730 is further to adapt to the structural characteristics where the rotating assembly 200 is fixed to the outer ring 620 and the fixing assembly 100 is fixed to the inner ring 610.

For example, the second extension protrusion 750 is closer to the first rotation axis than the first main body 730.

For example, the second locking portion 421 is a gear-like structure around the first rotation axis. The first locking portion 710 is a first tooth 710.

In some implementations, the second extension protrusion 750 is located on an end of the first main body 730. The second extension protrusion 750 includes a first extension portion 751 and a second extension portion 752. The first main body 730, the first extension portion 751, and the second extension portion 752 are connected in sequence. The second extension portion 752 extends along the sliding direction of the first main body 730. The first locking portion 710 is arranged on the second extension portion 752. The rotating assembly 200 defines a second sliding groove 2010 adapted to the second extension portion 752. The second extension portion 752 is slidably arranged in the second sliding groove 2010.

It can be understood that the slidable installation of the second extension portion 752 in the second sliding groove 2010 further stabilizes the sliding of the first locking member 700 relative to the rotating assembly 200 and reduces the deflection of the first locking member 700 relative to the rotating assembly 200 during the locking engagement with the second locking member 420.

It can be understood that when the first locking portion 710 is a first tooth 710 and the second locking portion 421 is a second tooth 421, in a case where the first tooth 710 is not aligned with the tooth groove 401 during engagement, the confinement of the second extension portion 752 within the second sliding groove 2010 may prevent deflection of the first locking member 700 caused by the engagement of the first tooth 710 and the tooth groove 401.

For example, the second extension protrusion 750 is “L”-shaped.

For example, the first extension portion 751 extends perpendicular to the sliding direction of the first main body 730 and extends inward.

In some implementations, the rotating assembly 200 further includes a second inner shell 230. The second inner shell 230 is located within the installation space 201. The second inner shell 230 is fixed relative to the first outer shell 210. The outer ring 620 is fixedly arranged on the second inner shell 230. The second inner shell 230 includes an outer sleeve 232 and a first limiting portion 231. A side surface of the outer ring 620 is sleeved on an inner side of the outer sleeve 232. The outer ring 620 is peripherally fixed relative to the second inner shell 230 about the first rotation axis (e.g., the outer ring 620 has an interference fit with the outer sleeve 232). The outer ring 620 cannot be detached from the second inner shell 230. The first limiting portion 231 is arranged on an end of the outer sleeve 232 and extends inward. A top end face of the outer ring 620 bears against the first limiting portion 231. The second sliding groove 2010 is arranged on the second inner shell 230. The second inner shell 230 further includes a third extension portion 233. The third extension portion 233 protrudes from the first limiting portion 231 and extends away from the outer sleeve 232. The second sliding groove 2010 is arranged on the third extension portion 233. The driving assembly 300 includes a driving main body 310 and an output shaft 320 rotatably arranged on the driving main body 310. The output shaft 320 is rotatable relative to the driving main body 310 to cause the rotating assembly 200 to rotate relative to the fixing assembly 100 about the first rotation axis. The driving assembly 300 further includes a first gear 330 fixed to the output shaft 320. The gimbal assembly 20 includes a second gear 410. The second gear 410 is coaxial with the first rotation axis. The second gear 410 is fixed relative to the fixing assembly 100. The second gear 410 meshes with the first gear 330. The fixing assembly 100 includes a second outer shell 110. The first outer shell 210 has a first opening 205 communicating with the installation space 201. The second outer shell 110 covers the first opening 205. The second gear 410 is peripherally fixed relative to the second outer shell 110 about the first rotation axis. The second locking member 420 is fixed relative to the second gear 410. The second outer shell 110 includes an end shell 111, a first inner sleeve 112, and a third limiting portion 113. The end shell 111 covers the first opening 205. The first inner sleeve 112 is arranged on the end shell 111 and extends into the installation space 201. The inner ring 610 is peripherally fixed relative to the second outer shell 110 about the first rotation axis (e.g., the inner ring 610 has an interference fit with the first inner sleeve 112). The inner ring 610 cannot be detached from the second outer shell 110. The third limiting portion 113 is arranged on the inner ring 610 or the end shell 111. The third limiting portion 113 is configured to bear against a bottom end face of the inner ring 610. The second gear 410 is peripherally fixed relative to the first inner sleeve 112 about the first rotation axis. The rotating assembly 200 further includes a first inner shell 220 and a mounting base 250 arranged on the first inner shell 220. The first inner shell 220 and the mounting base 250 are located within the installation space 201. The first main body 730 is confined between the first inner shell 220 and the first outer shell 210. The driving main body 310 is arranged on the mounting base 250. The driving main body 310 and the first inner shell 220 are located on a side of the mounting base 250 away from the second outer shell 110. A transmission space is defined between the mounting base 250 and the second outer shell 110. The output shaft 320 extends into the transmission space. The second inner shell 230, the first gear 330, the second gear 410, the bearing 600, and the locking assembly are located in the transmission space. The second inner shell 230 is fixedly arranged on the mounting base 250. The mounting base 250 is fixedly arranged on the first outer shell 210. The second inner shell 230 is arranged on the mounting base 250 via a fifth fastener 240. A head of the fifth fastener 240 serves as a second limiting portion 241. The outer ring 620 is located between the second limiting portion 241 and the first limiting portion 231 to prevent the outer ring 620 from detaching from the second inner shell 230. The second locking member 420 serves as a fourth limiting portion 421. The inner ring 610 is located between the third limiting portion 113 and the fourth limiting portion 421 to prevent the inner ring 610 from detaching from the second outer shell 110.

It can be understood that the interference fit between the outer sleeve 232 and the outer ring 620 may achieve peripheral fixation of the outer ring 620 relative to the rotating assembly 200 about the first rotation axis. Alternatively, tight contact between the first limiting portion 231 and the outer ring 620 may achieve this fixation. Alternatively, tight contact between the second limiting portion 241 and the outer ring 620 may achieve this fixation.

It can be understood that the interference fit between the inner ring 610 and the first inner sleeve 112 may achieve peripheral fixation of the inner ring 610 relative to the fixing assembly 100 about the first rotation axis. Alternatively, tight contact between the third limiting portion 113 and the inner ring 610 may achieve this fixation. Alternatively, tight contact between the fourth limiting portion 421 and the inner ring 610 may achieve this fixation.

It can be understood that the advantage of providing the first limiting portion 231 is that when the gimbal assembly 20 supports the electronic terminal 90, it prevents relative displacement between the rotating assembly 200 and the outer ring 620, thereby preventing the outer ring 620 from detaching from the rotating assembly 200 when the gimbal assembly 20 is supporting the electronic terminal 90.

It can be understood that the advantage of providing the second limiting portion 241 is that it prevents the outer ring 620 from detaching from the rotating assembly 200 when the user lifts the connecting arm 900 or the rotating assembly 200. For example, the second limiting portion 241 contacts or is near the bottom end face of the outer ring 620.

It can be understood that the advantage of providing the third limiting portion 113 is that it prevents the inner ring 610 from detaching from the fixing assembly 100 when the gimbal assembly 20 supports the electronic terminal 90.

It can be understood that the advantage of providing the fourth limiting portion 421 is that it prevents the inner ring 610 from detaching from the fixing assembly 100 when the user lifts the connecting arm 900 or the rotating assembly 200. For example, the fourth limiting portion 421 contacts or is near the top end face of the inner ring 610.

It can be understood that using the second locking member 420 further as the fourth limiting portion 421 makes the structure of the gimbal assembly 20 more compact.

It can be understood that providing the second sliding groove 2010 on the second inner shell 230 makes the structure of the gimbal assembly 20 more compact.

It can be understood that the second outer shell 110 covering the first opening 205 reduces the possibility of external objects entering the installation space 201.

It can be understood that a gap may be defined between the second outer shell 110 and the first opening 205 to avoid interference during the rotation of the rotating assembly 200 relative to the fixing assembly 100.

For example, the first inner shell 220 and the mounting base 250 are integrally formed. The mounting base 250 is fixedly arranged on the first outer shell 210, thereby fixing the first inner shell 220 to the first outer shell 210. Specifically, the mounting base 250 is fixed to the first outer shell 210 via a third fastener 251. The inner wall of the first outer shell 210 is arranged with a first connection post 213. The third fastener 251 passes through the mounting base 250 and is fastened to the first connection post 213. In a case where the third fastener 251 is a threaded fastener, the first connection post 213 defines a threaded hole adapted to the third fastener 251. The number of the third fasteners 251 may be two, and the number of the first connection posts 213 may be two. The two first connection posts 213 are respectively near opposite sides of the first outer shell 210.

In other examples, the third fastener 251 passes through the first inner shell 220 and is fastened to the mounting base 250.

In other examples, the third fastener 251 may be a rivet.

For example, the driving main body 310 is fixedly arranged on the mounting base 250. Specifically, the driving main body 310 is fixed to the mounting base 250 via a fourth fastener 252. The fourth fastener 252 passes through the mounting base 250 and is fastened to the driving main body 310. In a case where the fourth fastener 252 is a threaded fastener, the driving main body 310 defines a threaded hole adapted to the fourth fastener 252 (e.g., a first end face 301 of the driving main body 310 defines this threaded hole). The number of the fourth fasteners 252 may be two, and the two threaded holes corresponding to the two fourth fasteners 252 are respectively near opposite sides of the driving main body 310. For example, the mounting base 250 defines a first through hole 2011. The output shaft 320 passes through the first through hole 2011 and extends into the transmission space.

In other examples, the fourth fastener 252 passes through the driving main body 310 and is then fastened to the mounting base 250.

In other examples, the fourth fastener 252 may be a rivet.

For example, the second inner shell 230 is fixedly arranged on the mounting base 250, thereby fixing the second inner shell 230 relative to the first outer shell 210. Specifically, the second inner shell 230 is fixed to the mounting base 250 via a fifth fastener 240. The fifth fastener 240 passes through the second inner shell 230 and is fastened to the mounting base 250. The fifth fastener 240 is a threaded fastener. The mounting base 250 defines a threaded hole adapted to the fifth fastener 240. The number of the fifth fasteners 240 may be three, and the three fifth fasteners 240 are evenly distributed around the first rotation axis. More specifically, the mounting base 250 is arranged with a second connection post 253. The second inner shell 230 is arranged with a third connection post 234. The fifth fastener 240 passes through the third connection post 234 and is fastened to the second connection post 253. More specifically, a space between the second inner shell 230 and the mounting base 250 is a first space 2012. It can be understood that the first space 2012 is part of the transmission space. The first gear 330 is located in the first space 2012. The second gear 410 is located in the first space 2012.

For example, the second connection post 253 extends towards the first space 2012. The first limiting portion 231 of the second inner shell 230 extends towards the first space 2012 to form a first fixing sleeve 235. The second connection post 253 is sleeved on an inner side of the first fixing sleeve 235, further preventing relative rotation between the mounting base 250 and the second inner shell 230, improving the integrity of the rotating assembly 200.

For example, the gimbal assembly 20 further includes a second limiting portion 241. The second limiting portion 241 is arranged on the second inner shell 230. The second limiting portion 241 prevents the rotating assembly 200 from being detached from the outer ring 620, for example, when the user lifts the connecting arm 900. Specifically, the second limiting portion 241 is arranged on the second inner shell 230. More specifically, the second limiting portion 241 is in tight contact with the outer ring 620 to provide frictional force for the peripheral fixation of the outer ring 620 relative to the rotating assembly 200 about the first rotation axis.

For example, the third connection post 234 is arranged on the outer sleeve 232. The third connection post 234 has a first connection hole 2013. The fifth fastener 240 passes through the first connection hole 2013 and is fastened to the second connection post 253. An end of the first connection hole 2013 is in communication with the end of the outer sleeve 232. The head of the fifth fastener 240 serves as the second limiting portion 241. Tightening the fifth fastener 240 causes the second limiting portion 241 to tightly contact the outer ring 620, and further causes the first limiting portion 231 to tightly contact the outer ring 620.

For example, the fifth fastener 240 may be a threaded fastener or a rivet. The first connection hole 2013 may be a threaded hole or a rivet hole.

It can be understood that the fifth fastener 240 is fastened to the rotating assembly 200. The fifth fastener 240 causes the first limiting portion 231 to tightly contact the top end face of the outer ring 620 and the second limiting portion 241 to tightly contact the bottom end face of the outer ring 620. The fifth fastener 240 further enables the second limiting portion 241 to be detachably arranged on the rotating assembly 200, facilitating the installation of the bearing 600 on the rotating assembly 200. The multiple uses of the fifth fastener 240 make the structure of the gimbal assembly 20 more compact.

For example, a side of the first connection hole 2013 is in communication with an inner sidewall of the outer sleeve 232. The advantage of this arrangement is that, on one hand, it facilitates sleeving the outer ring 620 on an inner side of the outer sleeve 232 when there is an interference fit between them (facilitating radial expansion of the outer sleeve 232), and on the other hand, it brings the head of the fifth fastener 240 closer to the outer ring 620.

In other implementations, the fifth fastener 240 passes through a second connecting body and is fastened to the rotating assembly 200 (or, the fifth fastener 240 passes through the rotating assembly 200 and is fastened to the second connecting body). The second limiting portion 241 is connected to the second connecting body, or the first limiting portion 231 is part of the second connecting body.

For example, the gimbal assembly 20 includes a first connecting body 430. The second locking member 420 is integrally or fixedly connected to the first connecting body 430. The second gear 410 is integrally or fixedly connected to the first connecting body 430. It can be understood that the second locking member 420 and the second gear 410 are coaxial. For example, the first connecting body 430 is plate-shaped.

For example, a sixth fastener 120 may be a threaded fastener or a rivet.

For example, the gimbal assembly 20 includes a sixth fastener 120. The sixth fastener 120 passes through the fixing assembly 100 and is fastened to the first connecting body 430; or, the sixth fastener 120 passes through the fixing assembly 100 and is fastened to the second gear 410.

In other implementations, the gimbal assembly 20 includes a sixth fastener 120. The sixth fastener 120 passes through the first connecting body 430 and is fastened to the fixing assembly 100. The sixth fastener 120 passes through the second gear 410 and is fastened to the fixing assembly 100. More specifically, the sixth fastener 120 is a threaded fastener. The second outer shell 110 includes a fourth connection post 114. The fourth connection post 114 is integrally or fixedly connected to the end shell 111. The sixth fastener 120 is fastened to the fourth connection post 114. The sixth fastener 120 causes the second locking member 420 to tightly contact the inner ring 610. The second gear 410, on one hand, meshes with the first gear 330 for transmission, and on the other hand, fixing the second gear 410 to the fixing assembly 100 enables the fourth limiting portion 421 to limit the bearing 600, thereby making the structure of the gimbal assembly 20 compact.

Merely as an example, the fourth connection post 114 is fixedly arranged on the support rod 11, fixing the fixing assembly 100 to the support rod 11. Merely as an example, the support rod 11 is a length-adjustable rod. The length-adjustable rod includes multiple sleeves that are sleeved sequentially. The fourth connection post 114 is inserted into a top sleeve of the length-adjustable rod. The fourth connection post 114 has an interference fit with the top sleeve to achieve fixed installation of the fourth connection post 114 on the support rod 11.

It can be understood that the sixth fastener 120 is fastened to the fixing assembly 100. The sixth fastener 120 causes the third limiting portion 113 to tightly contact the bottom end face of the inner ring 610, and the fourth limiting portion 421 to tightly contact the top end face of the inner ring 610.

In other implementations, the fourth limiting portion 421 is the head of the sixth fastener 120.

In other implementations, the fourth limiting portion 421 is part of the first connecting body 430.

For example, the first connecting body 430 extends to form a second inner sleeve 440. The second inner sleeve 440 is sleeved on an inner side of the inner ring 610. The second inner sleeve 440 is peripherally fixed relative to the first inner sleeve 112 about the first rotation axis. The second inner sleeve 440 is embedded in the first inner sleeve 112. For example, an end face of the first inner sleeve 112 defines a second groove 101. An end face of the second inner sleeve 440 near the first inner sleeve 112 is arranged with a second protrusion 441. The second protrusion 441 is embedded in the second groove 101 to peripherally fix the second inner sleeve 440 relative to the first inner sleeve 112 about the first rotation axis.

In other examples, the first inner sleeve 112 is embedded in the second inner sleeve 440 to achieve peripheral fixation of the second inner sleeve 440 relative to the first inner sleeve 112 about the first rotation axis. For example, the second groove 101 is arranged on the second inner sleeve 440, and the second protrusion 441 is arranged on the first inner sleeve 112.

For example, the fourth connection post 114 is sleeved on an inner side of the second inner sleeve 440. Reinforcement ribs are provided between the fourth connection post 114 and the second inner sleeve 440.

Some embodiments of the present disclosure further propose a gimbal assembly 20 for a terminal stand. The gimbal assembly 20 includes a fixing assembly 100, a rotating assembly 200, a driving assembly 300, and a locking assembly. The rotating assembly 200 is rotatable relative to the fixing assembly 100 about a first rotation axis. The driving assembly 300 is configured to drive the rotating assembly 200 to rotate relative to the fixing assembly 100. The locking assembly includes a first locking member 700 and a second locking member 420. The first locking member 700 is fixedly arranged on the rotating assembly 200. The second locking member 420 is arranged on the fixing assembly 100. The second locking member 420 is movable relative to the fixing assembly 100 to be engaged with or disengaged from the first locking member 700. The engagement of the second locking member 420 with the first locking member 700 fixes the rotating assembly 200 relative to the fixing assembly 100 about the first rotation axis. The disengagement of the first locking member 700 from the second locking member 420 enables the rotating assembly 200 to rotate relative to the fixing assembly 100 about the first rotation axis.

For example, the second locking member 420 is slidable relative to the fixing assembly 100.

For example, the second locking member 420 is rotatable relative to the fixing assembly 100.

Some embodiments of the present disclosure further provide a terminal stand. The terminal stand includes a support member 10, a holding assembly, and a gimbal assembly 20. The support member 10 is configured to support the gimbal assembly 20 and the holding assembly. The fixing assembly 100 of the gimbal assembly 20 is arranged on the support member 10. The holding assembly is arranged on the rotating assembly 200 of the gimbal assembly 20. The holding assembly is configured to hold an electronic terminal 90.

For example, the holding assembly includes a connecting arm 900 and a holding member 40. The holding member 40 is arranged on the connecting arm 900. The holding member 40 is configured to hold the electronic terminal 90. The connecting arm 900 is arranged on the gimbal assembly 20. For instance, the connecting arm 900 is arranged on the rotating assembly 200 of the gimbal assembly 20.

Some embodiments of the present disclosure further provide a terminal stand. The terminal stand includes a support member 10, a connecting arm 900, a holding member 40, and a gimbal assembly 20. The support member 10 is configured to support the gimbal assembly 20, the connecting arm 900, and the holding member 40. The fixing assembly 100 of the gimbal assembly 20 is arranged on the support member 10. The connecting arm 900 is arranged on the rotating assembly 200 of the gimbal assembly 20. The holding member 40 is arranged on the connecting arm 900. The holding member 40 is configured to hold the electronic terminal 90. The connecting arm 900 is rotatably arranged on a first outer shell 210 of the rotating assembly 200. The connecting arm 900 is foldable against the first outer shell 210. When the connecting arm 900 is folded against the first outer shell 210, the connecting arm 900 obscures the toggle protrusion 720. It can be understood that when the terminal stand is required to be stored, the connecting arm 900, when folded, obscures the toggle protrusion 720, thereby preventing external objects from touching the toggle protrusion 720 and activating the gimbal assembly 20.

Some embodiments of the present disclosure further provide a terminal stand. The terminal stand includes a support member 10, a gimbal assembly 20, a connecting arm 900, and a holding member 40. The support member 10 is configured to support the gimbal assembly 20, the connecting arm 900, and the holding member 40. The gimbal assembly 20 includes a fixing assembly 100, a rotating assembly 200, and a driving assembly 300. The rotating assembly 200 is rotatable relative to the fixing assembly 100 about a first rotation axis. The driving assembly 300 is configured to drive the rotating assembly 200 to rotate relative to the fixing assembly 100. The fixing assembly 100 is arranged on the support member 10. The connecting arm 900 is rotatably arranged on the rotating assembly 200. The connecting arm 900 is foldable against the rotating assembly 200. The holding member 40 is arranged on the connecting arm 900. The holding member 40 is configured to hold the electronic terminal 90. The terminal stand further includes an accessory 260. The accessory 260 is arranged on the rotating assembly 200 and is in an exposed state relative to the rotating assembly 200. When the connecting arm 900 is folded against the rotating assembly 200, the connecting arm 900 obscures the accessory 260.

It can be understood that when the connecting arm 900 is folded against the rotating assembly 200, the accessory 260 is folded/obscured, which prevents damage to the accessory 260 by external objects in certain situations, thereby protecting the accessory 260; or prevents external objects from touching the accessory 260 in some situations, which could activate the gimbal assembly 20.

It can be understood that the connecting arm 900 obscuring the accessory 260 may mean that the connecting arm 900 encloses the accessory 260 within the rotating assembly 200.

It can be understood that the connecting arm 900 folding over the accessory 260 may mean that the connecting arm 900 partially encloses the accessory 260 within the rotating assembly 200.

In some implementations, the rotating assembly 200 includes a first outer shell 210. The first outer shell 210 encloses to define an installation space 201. The driving assembly 300 is located within the installation space 201. The accessory 260 is arranged on the first outer shell 210 and is in an exposed state relative to the first outer shell 210. The connecting arm 900 is foldable against the first outer shell 210. When the connecting arm 900 is folded against the first outer shell 210, the connecting arm 900 obscures the accessory 260.

In some implementations, the accessory 260 is an operable movable member 261. The movable member 261 is movably arranged on the first outer shell 210. When the movable member 261 moves to a first position, the driving assembly 300 stops, and/or, when the movable member 261 moves to the first position, the rotating assembly 200 is locked relative to the fixing assembly 100. When the movable member 261 moves to a second position, the rotating assembly 200 is rotatable relative to the fixing assembly 100.

It can be understood that the movable member 261 can cause the driving assembly 300 to stop. When storing the terminal stand, the connecting arm 900 obscuring the movable member 261 may prevent external objects from touching the movable member 261 and starting the driving assembly 300 in some situations.

It can be understood that the movable member 261 can lock the rotating assembly 200 relative to the fixing assembly 100. When the terminal stand is required to be stored, the connecting arm 900 folding over the movable member 261 may prevent external objects from touching the movable member 261 and unlocking the rotating assembly 200 relative to the fixing assembly 100 in some situations.

For example, the movable member 261 is slidably arranged on the first outer shell 210, or the movable member 261 is rotatably arranged on the first outer shell 210.

In some implementations, the movable member 261 is a toggle protrusion 720. The toggle protrusion 720 is slidably arranged on the first outer shell 210.

In some implementations, the gimbal assembly 20 further includes a first switch 550. The first switch 550 is electrically connected to the driving assembly 300. The first switch 550 has an ON state and an OFF state. When the first switch 550 is in the OFF state, the driving assembly 300 stops. When the movable member 261 moves to the first position, the first switch 550 is in the OFF state. When the movable member 261 moves to the second position, the first switch 550 is in the ON state. And/or, the gimbal assembly 20 further includes a first locking member 700 and a second locking member 420. The first locking member 700 is movably arranged on the rotating assembly 200. The second locking member 420 is fixedly arranged on the fixing assembly 100. The first locking member 700 includes the movable member 261. When the movable member 261 moves to the first position, the first locking member 700 and the second locking member 420 are locked together. When the movable member 261 moves to the second position, the first locking member 700 and the second locking member 420 are disengaged.

In some implementations, the accessory 260 is a tracking camera 262. The gimbal assembly 20 further includes a follow-shot chip. The follow-shot chip is electrically connected to the tracking camera 262. The follow-shot chip is electrically connected to the driving assembly 300. The follow-shot chip is arranged on the rotating assembly 200. The tracking camera 262 can capture images of a tracked person or object to put the terminal stand in a follow-shot state. The follow-shot chip is configured to process the images from the tracking camera 262 to control the driving assembly 300 to drive the rotating assembly 200 such that the tracked person or object remains in the center of the frame of the follow-shot camera. The electronic terminal 90 includes a shooting lens 91. When the terminal stand is in the follow-shot state, the shooting lens 91 can capture the tracked person or object.

It can be understood that the shooting lens 91 utilizes a follow-shot lens to achieve tracking shots of the tracked person or object.

For example, when the terminal stand is in the follow-shot state, the shooting lens 91 and the tracking camera 262 are located on a same side of the terminal stand.

For example, when the terminal stand is in the follow-shot state, the optical axis of the shooting lens 91 is parallel to the optical axis of the tracking camera 262.

For example, when the terminal stand is in the follow-shot state, there is an angle between the optical axis of the shooting lens 91 and the optical axis of the tracking camera 262.

In some implementations, the follow-shot chip is located within the installation space 201.

In some implementations, the accessory 260 has an exposed wall 260a relative to the rotating assembly 200. There is a point A defined on the exposed wall 260a. Point A is all or some of the points on the exposed wall 260a. A line perpendicular to the first rotation axis and passing through point A is defined as a first line. A first projection plane is defined perpendicular to the first line. When the connecting arm 900 obscures the accessory 260, the orthogonal projection of the point A on the first projection plane is point A1. The orthogonal projection of the connecting arm 900 on the first projection plane is an arm projection. The point A1 is located within the arm projection.

It can be understood that when point A1 is located within the arm projection, point A is obscured by the connecting arm 900.

It can be understood that when point A represents all points on the exposed wall 260a, the connecting arm 900 completely obscures the exposed wall 260a in the direction along the first line.

It can be understood that when point A represents a subset of points on the exposed wall 260a, the connecting arm 900 partially obscures the exposed wall 260a in the direction along the first line.

In some implementations, the accessory 260 has an exposed wall 260a relative to the first outer shell 210.

Implementing the terminal stand according to the embodiments of the present disclosure provides the following beneficial effects: By arranging the power source in the connecting arm of the terminal stand, the power source is located outside the gimbal assembly. This configuration eliminates the need for the gimbal assembly to reserve additional space for the power source, thereby reducing the volume occupied by the gimbal assembly. The gimbal assembly is more proportionate in size to other parts of the terminal stand, avoiding issues such as interference between the rotating component and the fixed component due to a power source bulge.

The above descriptions are merely intended to illustrate the technical solutions of the present disclosure but not to limit them. Other modifications or equivalent replacements made to the technical solutions of the present disclosure by those skilled in the art, without departing from the spirit and scope of the technical solutions of the present disclosure, shall fall within the protection scope of the claims of the present disclosure.

What is claimed is:

1. A terminal stand, comprising a support member, a gimbal assembly, a connecting arm, a power source, and a holding member;
wherein the support member is configured to support the gimbal assembly, the connecting arm, the power source, and the holding member;
the gimbal assembly comprises a fixing assembly, a rotating assembly, and a driving assembly; the fixing assembly is arranged on the support member; the rotating assembly is rotatable relative to the fixing assembly about a first rotation axis; the gimbal assembly defines an installation space, and the driving assembly is arranged within the installation space and is configured to drive the rotating assembly to rotate relative to the fixing assembly;
the connecting arm is arranged on the rotating assembly; the power source is located outside the gimbal assembly and is electrically connected to the driving assembly;
the holding member is arranged on the connecting arm and is configured to hold an electronic terminal.

2. The terminal stand according to claim 1, wherein the connecting arm defines an accommodation cavity, and the power source is arranged within the accommodation cavity.

3. The terminal stand according to claim 2, wherein the driving assembly is arranged on the rotating assembly, and the connecting arm is rotatably arranged on the rotating assembly about a second rotation axis;
the terminal stand comprises a connecting wire; an end of the connecting wire extends to the accommodation cavity, and another end of the connecting wire extends to the installation space; the connecting wire is configured to supply power from the power source to the driving assembly;
the rotating assembly is arranged with a first wire passage for the connecting wire to pass through, the first wire passage communicating with the installation space;
the connecting arm is arranged with a second wire passage for the connecting wire to pass through, the second wire passage communicating with the first wire passage and communicating with the accommodation cavity;
during rotation of the connecting arm relative to the rotating assembly about the second rotation axis, the first wire passage and the second wire passage remain in communication to facilitate the connecting wire passing through the first wire passage and the second wire passage.

4. The terminal stand according to claim 3, wherein the first wire passage comprises a first wire port near the second wire passage, the second wire passage comprises a second wire port near the first wire passage, and the first wire port and the second wire port are connected to or close to each other;
both the first wire port and the second wire port are revolving ports, and both are coaxial with the second rotation axis.

5. The terminal stand according to claim 4, wherein the rotating assembly comprises a first installation protrusion and a second installation protrusion that are spaced apart, and the first wire passage extends to the first installation protrusion;
the connecting arm comprises a connection protrusion, the connection protrusion comprising a first connection portion and a second connection portion that are arranged side by side;
the second wire passage extends to the first connection portion; the first connection portion is connected to or close to the first installation protrusion, causing the first wire passage to be communicated with the second wire passage;
the second connection portion is rotatably arranged on the second installation protrusion, causing the connecting arm to be rotatably arranged on the rotating assembly.

6. The terminal stand according to claim 5, wherein the terminal stand further comprises a first rotation pin; the first rotation pin passes through the second connection portion and the second installation protrusion to rotatably arrange the second connection portion on the second installation protrusion;
a first fastener serves as the first rotation pin and is further configured to hold the connecting arm in position relative to the rotating assembly;
the second connection portion comprises at least one first connection plate spaced apart; the second installation protrusion comprises at least one second connection plate arranged spaced apart; the at least one first connection plate and the at least one second connection plate are arranged in an interleaved manner, and both the at least one first connection plate and the at least one second connection plate are sheet-like;
the first fastener is configured to cause an adjacent set of a corresponding first connection plate of the at least one first connection plate and a corresponding second connection plate of the at least one second connection plate to be in contact.

7. The terminal stand according to claim 5, wherein the terminal stand further comprises a first rotation pin; the first rotation pin passes through the second connection portion and the second installation protrusion to rotatably arrange the second connection portion on the second installation protrusion;
a first fastener serves as the first rotation pin and is further configured to hold the connecting arm in position relative to the rotating assembly;
the first fastener comprises a nut and a screw that are configured to be cooperatively engaged; in a case where the second connection portion rotates relative to the second installation protrusion, both the nut and the screw remain stationary relative to the second installation protrusion, or both the nut and the screw remain stationary relative to the second connection portion;
the first connection portion is located between the first installation protrusion and the second installation protrusion, and the first connection portion defines an accommodation groove, the nut being accommodated in the accommodation groove;
the nut is peripherally fixed relative to the second installation protrusion or the second connection portion about the second rotation axis; a head of the screw comprises an adjustment portion, and the adjustment portion of the screw is capable of being adjusted to fasten the first fastener;
the connecting arm defines a second opening, and the second opening is in communication with the accommodation cavity; the power source is configured to be arranged into the accommodation cavity through the second opening; the second opening is in communication with the second wire passage, and the second opening is in communication with the accommodation groove; the nut is configured to be arranged into the accommodation groove through the second opening;
the terminal stand further comprises a cover; the cover matches the second opening and is detachably arranged on the connecting arm; the cover is capable of sealing the second opening.

8. The terminal stand according to claim 5, wherein the terminal stand further comprises a first rotation pin; the first rotation pin passes through the second connection portion and the second installation protrusion to rotatably arrange the second connection portion on the second installation protrusion;
a first fastener serves as the first rotation pin and is further configured to hold the connecting arm in position relative to the rotating assembly;
the second connection portion comprises at least one first connection plate spaced apart; the second installation protrusion comprises at least one second connection plate arranged spaced apart; the first fastener is configured to cause an adjacent set of a corresponding first connection plate of the at least one first connection plate and a corresponding second connection plate of the at least one second connection plate to be in contact;
the first fastener comprises a nut and a screw that are configured to be cooperatively engaged; in a case where the second connection portion rotates relative to the second installation protrusion, both the nut and the screw remain stationary relative to the second installation protrusion, or both the nut and the screw remain stationary relative to the second connection portion;
the first connection portion is located between the first installation protrusion and the second installation protrusion, and the first connection portion defines an accommodation groove;
a side of the second installation protrusion close to the first connection portion is arranged with a third protrusion; the third protrusion is accommodated in the accommodation groove, and the third protrusion defines an installation groove; the nut is arranged in the installation groove and accommodated in the accommodation groove; the nut is peripherally fixed relative to the installation groove about the second rotation axis; a head of the screw comprises an adjustment portion, and the adjustment portion of the screw is capable of being adjusted to fasten the first fastener;
the connecting arm defines a second opening, and the second opening is in communication with the accommodation cavity; the power source is configured to be arranged into the accommodation cavity through the second opening; the second opening is in communication with the accommodation groove; the third protrusion is configured to be arranged into the accommodation groove through the second opening; the nut is configured to be arranged into the installation groove through the second opening; the second opening is in communication with the second wire passage;
the terminal stand further comprises a cover; the cover matches the second opening and is detachably arranged on the connecting arm; the cover is capable of sealing the second opening; one of the at least one second connection plate is a second connection sub-plate, the second connection sub-plate is adjacent to or in contact with the first connection portion, and the third protrusion is arranged on the second connection sub-plate.

9. The terminal stand according to claim 1, wherein the driving assembly is arranged on the rotating assembly; the driving assembly comprises a driving main body and an output shaft; the output shaft is rotatably arranged on the driving main body, the driving main body is fixed on the rotating assembly, and the output shaft is transmission-connected to the fixing assembly; and the output shaft is rotatable relative to the driving main body, causing the rotating assembly to rotate relative to the fixing assembly about the first rotation axis;
the driving assembly further comprises a first gear fixed on the output shaft; the gimbal assembly comprises a second gear fixed relative to the fixing assembly; the second gear meshes with the first gear, and the second gear is coaxial with the first rotation axis.

10. The terminal stand according to claim 9, wherein the gimbal assembly further comprises a circuit board assembly arranged on the rotating assembly, and the circuit board assembly is located in the installation space;
the circuit board assembly comprises a first circuit board and a second circuit board electrically connected to the first circuit board; the second circuit board or the first circuit board is electrically connected to the driving assembly;
the driving main body has a first end face; the output shaft extends out from the first end face, and the circuit board assembly is located on a side of the driving main body away from the output shaft;
the rotating assembly comprises a first outer shell, and the first outer shell encloses to define the installation space; the first circuit board and the second circuit board are arranged spaced apart, and the first rotation axis is located between the first circuit board and the second circuit board.

11. The terminal stand according to claim 1, wherein the gimbal assembly further comprises a bearing; the bearing is located within the installation space, and the bearing comprises an inner ring, an outer ring, and rolling elements; the inner ring is sleeved on an inner side of the outer ring, and the rolling elements are rollably arranged between the inner ring and the outer ring; wherein,
the inner ring is peripherally fixed relative to the fixing assembly about the first rotation axis; the outer ring is peripherally fixed relative to the rotating assembly about the first rotation axis; the inner ring is unable to be detached from the fixing assembly, and the outer ring is unable be detached from the rotating assembly; or,
the inner ring is peripherally fixed relative to the rotating assembly about the first rotation axis; the outer ring is peripherally fixed relative to the fixing assembly about the first rotation axis; the inner ring is unable to be detached from the rotating assembly, and the outer ring is unable be detached from the fixing assembly.

12. The terminal stand according to claim 11, wherein the outer ring is sleeved on an inner side of the rotating assembly; the outer ring is peripherally fixed relative to the rotating assembly about the first rotation axis; the gimbal assembly comprises a first limiting portion and a second limiting portion; a top end face of the outer ring is configured to bear against the first limiting portion to enable the outer ring to support the rotating assembly; the outer ring is located between the first limiting portion and the second limiting portion, causing the outer ring to be unable to be detached from the rotating assembly; the fixing assembly is sleeved on an inner side of the inner ring; the inner ring is peripherally fixed relative to the fixing assembly about the first rotation axis; the gimbal assembly further comprises a third limiting portion and a fourth limiting portion; the third limiting portion is configured to bear against a bottom end face of the inner ring to enable the fixing assembly to support the inner ring; the inner ring is located between the third limiting portion and the fourth limiting portion, causing the inner ring to be unable to be detached from the rotating assembly; or,
the rotating assembly is sleeved on an inner side of the inner ring; the inner ring is peripherally fixed relative to the rotating assembly about the first rotation axis; the gimbal assembly comprises a first limiting portion and a second limiting portion; a top end face of the inner ring is configured to bear against the first limiting portion to enable the inner ring to support the rotating assembly; the inner ring is located between the first limiting portion and the second limiting portion, causing the inner ring to be unable to be detached from the rotating assembly; the outer ring is sleeved on an inner side of the fixing assembly; the outer ring is peripherally fixed relative to the fixing assembly about the first rotation axis; the gimbal assembly further comprises a third limiting portion and a fourth limiting portion; the third limiting portion is configured to bear against a bottom end face of the outer ring to enable the fixing assembly to support the inner ring; the outer ring is located between the third limiting portion and the fourth limiting portion, causing the outer ring to be unable to be detached from the fixing assembly.

13. The terminal stand according to claim 2, wherein the connecting arm comprises a connection main body; the power source is located within the connection main body; both the connection main body and the power source are columnar, and a cross-sectional area of the power source is greater than or equal to 50% of a cross-sectional area of the connection main body;
the power source and the connection main body extend in a same direction, and a length of the power source is greater than or equal to 50% of a length of the connection main body.

14. The terminal stand according to claim 1, wherein the rotating assembly comprises a first outer shell, and the first outer shell encloses to define the installation space; the connecting arm is arranged on the first outer shell.

15. The terminal stand according to claim 1, wherein the connecting arm is rotatably arranged on the rotating assembly, and the connecting arm is foldable against the gimbal assembly.

16. The terminal stand according to claim 15, wherein the connecting arm is capable of being held in position relative to the rotating assembly; the connecting arm is rotatably arranged on the rotating assembly about a second rotation axis, and an angle between the second rotation axis and the first rotation axis is greater than or equal to 75 degrees and less than or equal to 90 degrees.

17. The terminal stand according to claim 15, wherein the terminal stand further comprises an accessory; the accessory is arranged on the rotating assembly and is in an exposed state relative to the rotating assembly; in a case where the connecting arm is folded against the rotating assembly, the connecting arm obscures the accessory.

18. The terminal stand according to claim 1, wherein the support member comprises a first support sub-portion and a support rod; the first support sub-portion is arranged on the support rod, and the first support sub-portion is configured to be held by a user;
an outer side wall of the first support sub-portion is a cylindrical surface or an approximately cylindrical surface; an outer side wall of the gimbal assembly is a cylindrical surface or an approximately cylindrical surface; an end of the gimbal assembly is connected to or close to an end of the first support sub-portion; the first support sub-portion and the gimbal assembly together form a first support structure; during rotation of the rotating assembly relative to the fixing assembly about the first rotation axis, the first support structure remains bar-shaped, and the first support structure is capable of being placed horizontally on a support surface; in a case where the first support structure is placed horizontally on the support surface, an angle between the first rotation axis and the support surface is less than or equal to 3 degrees.

19. The terminal stand according to claim 18, wherein the support rod is a length-adjustable rod; the length-adjustable rod is extendable to cause the gimbal assembly to move away from the first support sub-portion, and the length-adjustable rod is retractable to cause the gimbal assembly to be connected to or close to the first support sub-portion;
the approximately cylindrical surface is capable of being placed horizontally on the support surface, and in a case where the approximately cylindrical surface rolls arbitrarily on the support surface, the angle between the first rotation axis and the support surface is less than or equal to 3 degrees.

20. The terminal stand according to claim 19, wherein the first support structure comprises a first support main body and the rotating assembly connected to or close to the first support main body; the first support main body comprises the first support sub-portion and the fixing assembly; an outer side wall of the first support main body is a first revolving port coaxial with the first rotation axis; an outer side wall of the rotating assembly is a second revolving port coaxial with the first rotation axis, and an overall outer side wall of the first support structure is a third revolving port coaxial with the first rotation axis.

21. The terminal stand according to claim 18, wherein in a case where the first support structure is placed horizontally on the support surface, the angle between the first rotation axis and the support surface is less than or equal to 1 degree.

22. The terminal stand according to claim 1, wherein the support member comprises at least three feet, at least three connecting rods, a sliding sleeve, and a support rod;
wherein the at least three connecting rods correspond to the at least three feet in a one-to-one correspondence; an end of each connecting rod of the at least three connecting rods is rotatably connected to the support rod, and another end of each connecting rod of the at least three connecting rods is rotatably connected to a corresponding foot of the at least three feet; each foot of the at least three feet is rotatably connected to the sliding sleeve, and the sliding sleeve is sleeved on the support rod;
in a case where the sliding sleeve slides relative to the support rod, the at least three feet are splayed or folded relative to the support rod;
after the at least three feet are splayed, the at least three feet is capable of supporting on a support surface;
after the at least three feet are folded, the at least three feet, the at least three connecting rods, and the sliding sleeve form a first support sub-portion, and the first support sub-portion is configured to be held by a user
the support rod is a length-adjustable rod.

23. The terminal stand according to claim 1, wherein the gimbal assembly further comprises a locking assembly; the locking assembly comprises a first locking member and a second locking member; the first locking member is movably arranged on the rotating assembly, and the second locking member is fixedly arranged on the fixing assembly; the first locking member is rotatable relative to the rotating assembly to cause the first locking member and the second locking member to be in locking engagement or disengaged; in a case where the first locking member and the second locking member are in locking engagement, the rotating assembly is fixed relative to the fixing assembly about the first rotation axis; in a case where the first locking member and the second locking member are disengaged, the rotating assembly is rotatable relative to the fixing assembly about the first rotation axis;
the first locking member is slidably arranged on the rotating assembly;
the rotating assembly comprises a first outer shell, and the first outer shell encloses to define the installation space; the driving assembly is located in the installation space, and the first outer shell defines a toggle groove;
the first locking member comprises a toggle protrusion; the toggle protrusion is configured to be adjusted by a user to cause the first locking member and the second locking member to be in locking engagement or disengaged; the toggle groove serves as a movement space for the toggle protrusion.

24. The terminal stand according to claim 23, wherein the connection arm is rotatably arranged on the first outer shell of the rotating assembly, and the connection arm is foldable against the first outer shell; in a case where the connection arm is folded against the first outer shell, the connection arm obscures the toggle protrusion.
